(19) United States
(12) Patent Application Publication
(10) Pub. No.: US 2025/0358819 A1
(43) Pub. Date: Nov. 20, 2025

(54) RESOURCE CONFIGURATION AND SELECTION FOR DOWNLINK SMALL DATA TRANSMISSIONS

(71) Applicant: QUALCOMM Incorporated, San Diego, CA (US)

(72) Inventors: Jing LEI, San Diego, CA (US); Ruiming ZHENG, Beijing (CN); Yiqing CAO, Beijing (CN)

(21) Appl. No.: 18/871,375

(22) PCT Filed: Jul. 29, 2022
(86) PCT No.: PCT/CN2022/108862

§ 371 Date: Dec. 3, 2024

(51) Int. Cl. H04W 72/21; H04W 72/115; H04W 72/23; H04W 74/0833; H04W 76/27

(52) U.S. Cl. CPC H04W 72/21; H04W 72/115; H04W 72/23; H04W 74/0833; H04W 76/27

(57) ABSTRACT

Various aspects of the present disclosure generally relate to wireless communication. In some aspects, a user equipment (UE) may receive, from a network node, an indication that the UE is to perform a mobile-terminated (MT) small data transmission (SDT) (MT-SDT) operation. The UE may transmit, to the network node, a communication in response to the indication using: a first uplink resource associated with a mobile originated (MO) SDT (MO-SDT) configuration based at least in part on one or more conditions being satisfied, or a second uplink resource associated with a random access configuration based at least in part on the one or more conditions not being satisfied or based at least in part on no MO-SDT configurations being configured for the UE. Numerous other aspects are described.

### FIELD OF THE DISCLOSURE

Aspects of the present disclosure generally relate to wireless communication and to techniques and apparatuses for resource configuration and selection for downlink small data transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, an indication that the UE is to perform a mobile-terminated (MT) small data transmission (SDT) (MT-SDT) operation. The method may include transmitting, to the network node, a communication in response to the indication using, a first uplink resource associated with a mobile-originated (MO) SDT (MO-SDT) configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to a method of wireless communication performed by a network node. The method may include transmitting an indication, intended for a UE, that the UE is to perform an MT-SDT operation. The method may include receiving a communication, associated with the UE, in response to the indication using, a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to a UE for wireless communication. The user equipment may include a memory and one or more processors coupled to the memory. The one or more processors may be configured to receive, from a network node, an indication that the UE is to perform an MT-SDT operation. The one or more processors may be configured to transmit, to the network node, a communication in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to a network node for wireless communication. The network node may include a memory and one or more processors coupled to the memory. The one or more processors may be configured to transmit an indication, intended for a UE, that the UE is to perform an MT-SDT operation. The one or more processors may be configured to receive a communication, associated with the UE, in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to a non-transitory computer-readable medium that stores a set of instructions for wireless communication by a UE. The set of instructions, when executed by one or more processors of the UE, may cause the UE to receive, from a network node, an indication that the UE is to perform an MT-SDT operation. The set of instructions, when executed by one or more processors of the UE, may cause the UE to transmit, to the network node, a communication in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to a non-transitory computer-readable medium that stores a set of instructions for wireless communication by a network node. The set of instructions, when executed by one or more processors of the network node, may cause the network node to transmit an indication, intended for a UE, that the UE is to perform a MT-SDT operation. The set of instructions, when executed by one or more processors of the network node, may cause the network node to receive a communication, associated with the UE, in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Some aspects described herein relate to an apparatus for wireless communication. The apparatus may include means for receiving, from a network node, an indication that the apparatus is to perform a MT-SDT operation. The apparatus may include means for transmitting, to the network node, a communication in response to the indication using, a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the apparatus.

Some aspects described herein relate to an apparatus for wireless communication. The apparatus may include means for transmitting an indication, intended for a UE, that the UE is to perform a MT-SDT operation. The apparatus may include means for receiving a communication, associated with the UE, in response to the indication using, a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example of a wireless network in which a UE may support additional communication modes, in accordance with the present disclosure.

FIG. 5 is a diagram illustrating an example of a two-step random access procedure associated with small data transmission (SDT), in accordance with the present disclosure.

FIG. 6 is a diagram illustrating an example of a four-step random access procedure associated with SDT, in accordance with the present disclosure.

FIG. 7 is a diagram illustrating an example of a configured grant (CG) SDT (CG-SDT) procedure, in accordance with the present disclosure.

FIG. 8 is a diagram of an example associated with resource configuration and selection for downlink small data transmissions, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

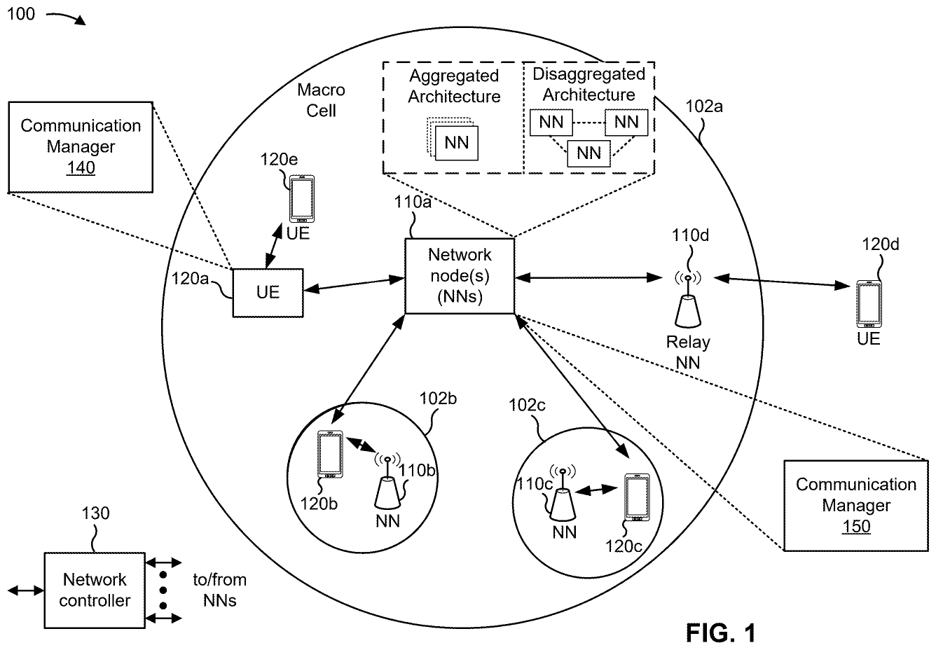

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU, and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, an indication that the UE is to perform a mobile-terminated (MT) small data transmission (SDT) (MT-SDT) operation; and transmit, to the network node, a communication in response to the indication using: a first uplink resource associated with a mobile-originated (MO) SDT (MO-SDT) configuration based at least in part on one or more conditions being satisfied, or a second uplink resource associated with a random access configuration based at least in part on the one or more conditions not being satisfied or based at least in part on no MO-SDT configurations being configured for the UE. Additionally, or alternatively, the communication manager 140 may perform one or more other operations described herein.

In some aspects, the network node 110 may include a communication manager 150. As described in more detail elsewhere herein, the communication manager 150 may transmit an indication, intended for a UE, that the UE is to perform an MT-SDT operation; and receive a communication, associated with the UE, in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE. Additionally, or alternatively, the communication manager 150 may perform one or more other operations described herein.

As indicated above, FIG. 1 is provided as an example. Other examples may differ from what is described with regard to FIG. 1.

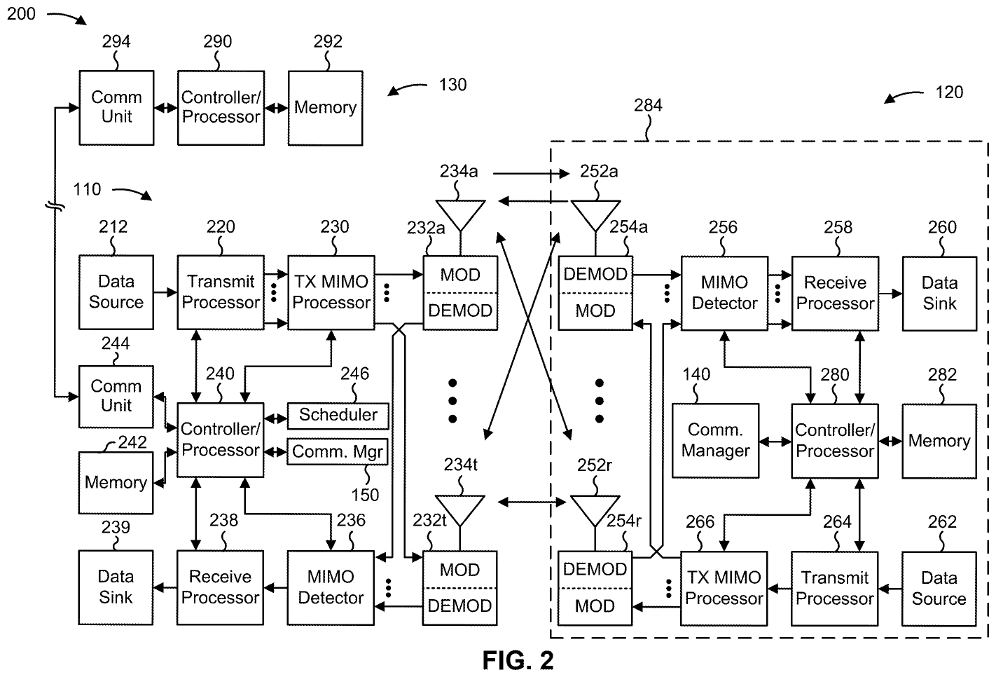

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

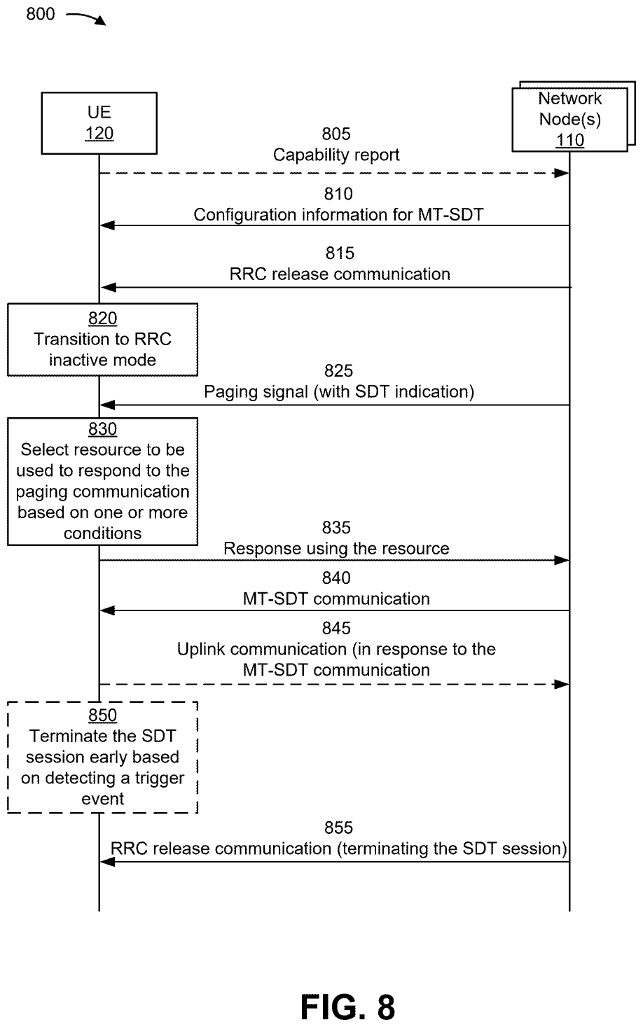

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

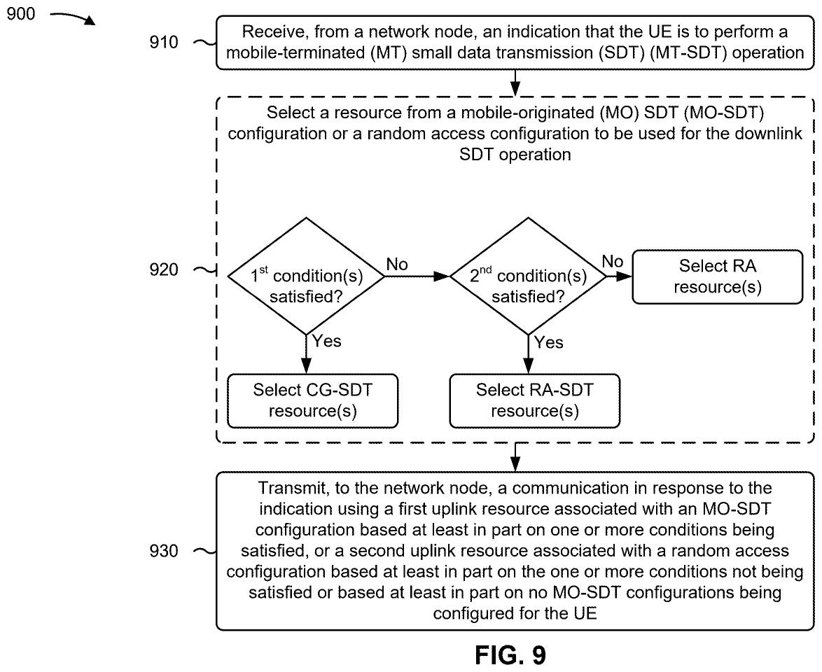

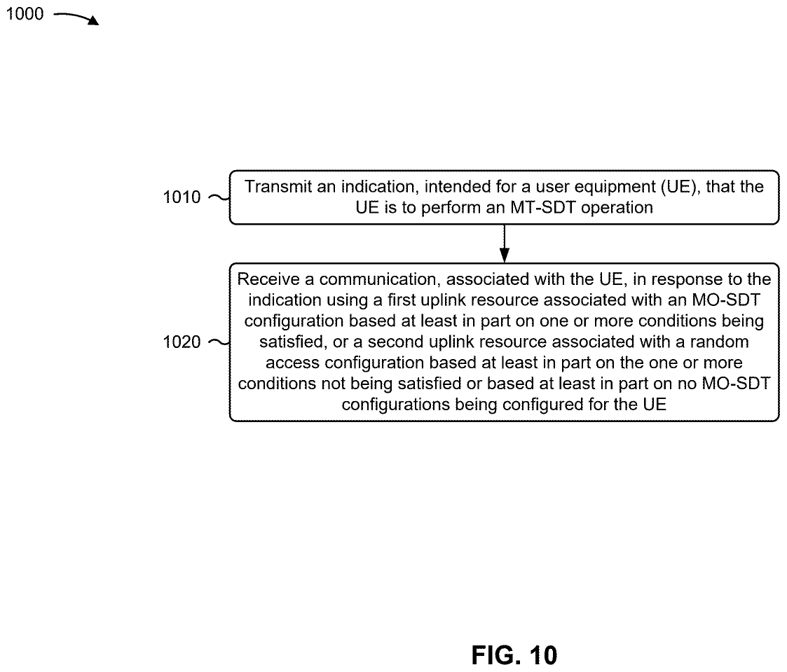

The controller/processor 240 of the network node 110, the controller/processor 280 of the UE 120, and/or any other component(s) of FIG. 2 may perform one or more techniques associated with resource configuration and selection for downlink small data transmissions, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a network node, an indication that the UE is to perform an MT-SDT operation; and/or means for transmitting, to the network node, a communication in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication, intended for a UE, that the UE is to perform an MT-SDT operation; and/or means for receiving a communication, associated with the UE, in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

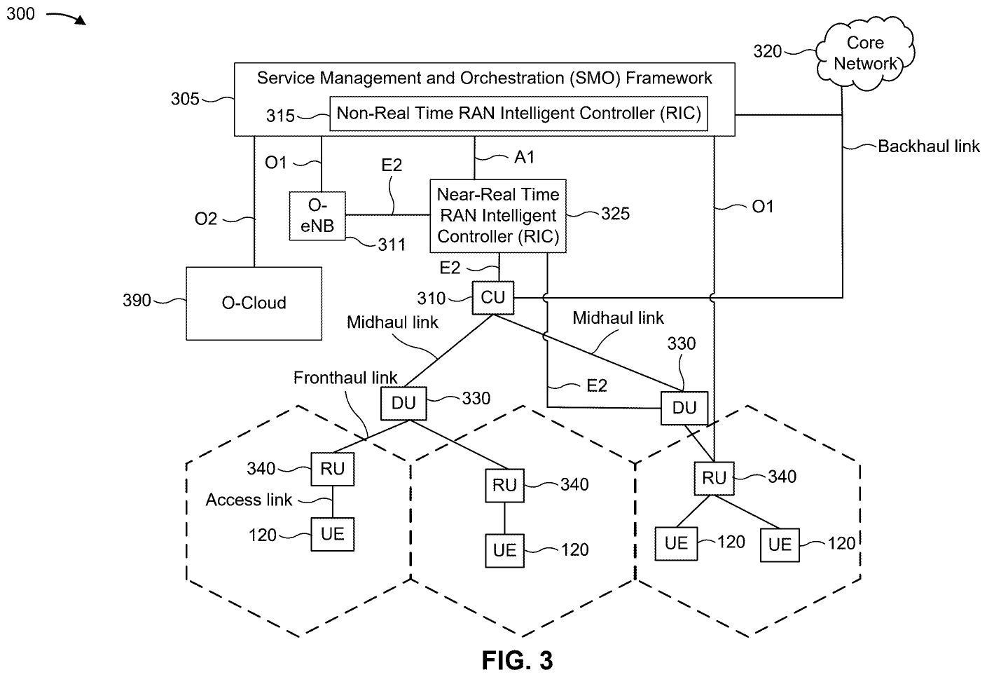

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

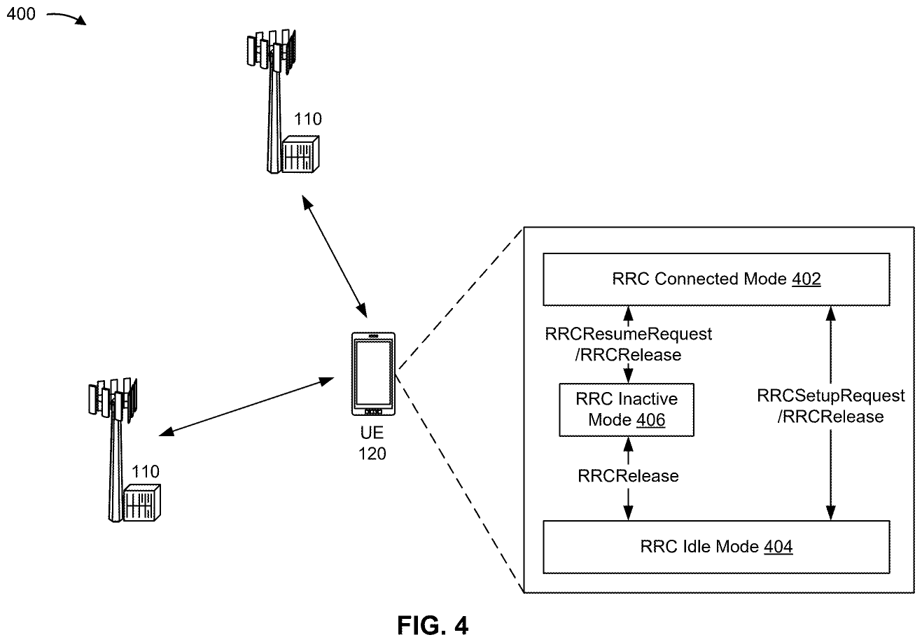

FIG. 4 illustrates an example 400 of a wireless network (e.g., wireless network 100) in which a UE (e.g., a UE 120) may support additional communication modes, in accordance with the present disclosure. The UE may be communicatively connected with one or more network nodes 110 in the wireless network. For example, the UE may be connected to the one or more network nodes 110 in a dual connectivity configuration. In this case, a first network node 110 may serve the UE as a master node and a second network node 110 may serve the UE as a secondary node.

As illustrated in FIG. 4, the UE may support a connected communication mode (e.g., an RRC connected mode 402), an idle communication mode (e.g., an RRC idle mode 404), and an inactive communication mode (e.g., an RRC inactive mode 406). The RRC connected mode 402 may be referred to as an RRC active mode. RRC inactive mode 406 may functionally reside between RRC connected mode 402 and RRC idle mode 404.

The UE may transition between different modes based at least in part on various commands and/or communications received from the one or more network nodes 110. For example, the UE may transition from RRC connected mode 402 or RRC inactive mode 406 to RRC idle mode 404 based at least in part on receiving an RRCRelease communication. As another example, the UE may transition from RRC connected mode 402 to RRC inactive mode 406 based at least in part on receiving an RRCRelease with suspendConfig communication. As another example, the UE may transition from RRC idle mode 404 to RRC connected mode 402 based at least in part on receiving an RRCSetupRequest communication. As another example, the UE may transition from RRC inactive mode 406 to RRC connected mode 402 based at least in part on receiving an RRCResumeRequest communication.

When transitioning to RRC inactive mode 406, the UE and/or the one or more network nodes 110 may store a UE context (e.g., an access stratum (AS) context and/or higher-layer configurations). This permits the UE and/or the one or more network nodes 110 to apply the stored UE context when the UE transitions from RRC inactive mode 406 to RRC connected mode 402 in order to resume communications with the one or more network nodes 110, which reduces latency of transitioning to RRC connected mode 402 relative to transitioning to the RRC connected mode 402 from RRC idle mode 404.

In some cases, the UE may communicatively connect with a new master node when transitioning from RRC idle mode 404 or RRC inactive mode 406 to RRC connected mode 402 (e.g., a master node that is different from the last serving master node when the UE transitioned to RRC idle mode 404 or RRC inactive mode 406). In this case, the new master node may be responsible for identifying a secondary node for the UE in the dual connectivity configuration.

In some cases, the UE 120 may be enabled to transmit and/or receive one or more communications (e.g., uplink communications and/or downlink communications) while operating in the RRC idle mode 404 or RRC inactive mode 406. For example, the UE 120 may be configured to perform SDT operations while operating in the RRC idle mode 404 or RRC inactive mode 406, as described in more detail elsewhere herein.

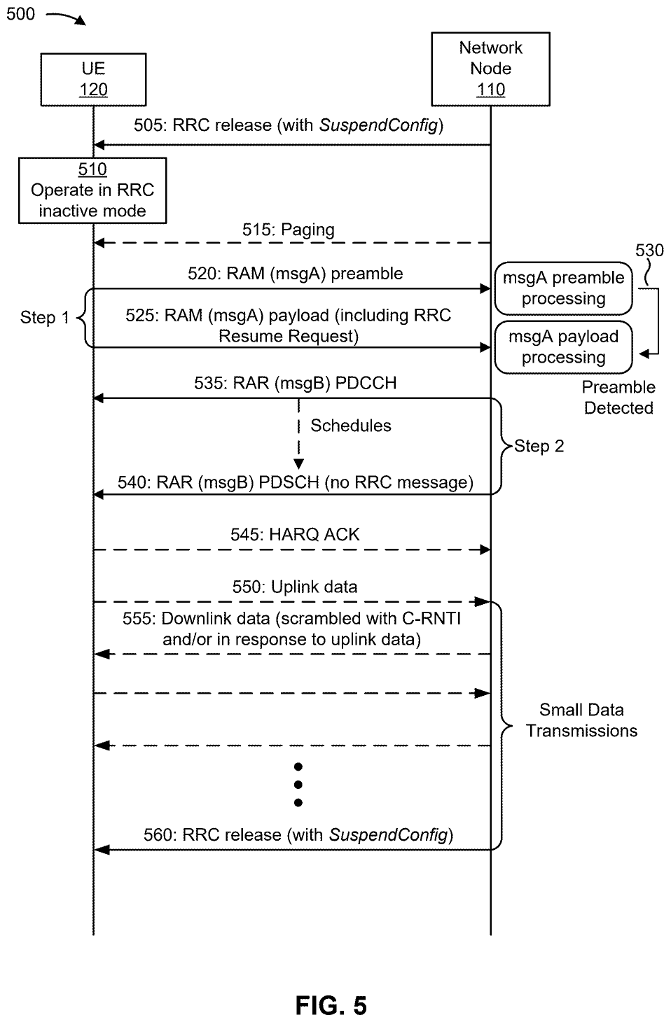

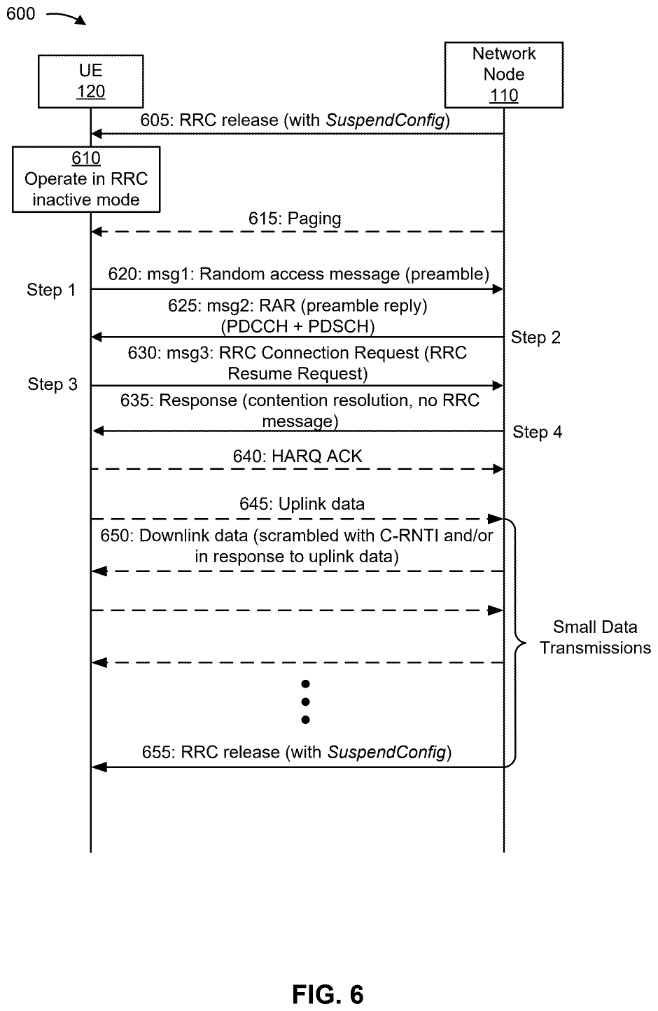

In some cases, SDT communications can be supported by UEs. For example, both 2-step (e.g., as depicted and described in connection with FIG. 5) and 4-step (e.g., as depicted and described in connection with FIG. 6) random access channel (RACH) procedures can be applied to random access (RA)-SDT in RRC inactive modes. The UE 120 can re-establish at least the SDT PDCP and resume the SDT radio bearers (RBs) that are configured for small data. In a subsequent data transmission (after successful contention resolution), a UE can monitor dynamic grant (DG) by cell-radio network temporary identifier (C-RNTI) in a separate common search space (CSS) (if configured) in RA-SDT. An RRC release message can be transmitted at the end of an SDT session to terminate the SDT procedure from the RRC perspective.

A configuration of configured grant (CG) resources for UE MO-SDT can be contained in the RRC release message. The RRC release message also can be used to reconfigure or release the CG-SDT resources while the UE 120 is in an RRC inactive mode. The configuration of CG resources may include type 1 CG configuration (e.g., as defined, or otherwise fixed, by a wireless communication standard, such as the 3GPP). Multiple CG-SDT configurations per carrier in RRC inactive mode can be supported by network configuration. For CG-SDT, the subsequent data transmission can use the CG resources for new data transmission or DG for retransmission.

In some examples, the UE 120 may be enabled to transmit uplink communications (e.g., while operating in the RRC inactive mode 406) using an MO-SDT procedure. Uplink SDT may be used interchangeably herein with MO-SDT. In some examples, the UE 120 may be enabled to receive downlink communications (e.g., while operating in the RRC inactive mode 406) using an MT-SDT procedure. MT-SDT may be used interchangeably herein with downlink SDT.

As indicated above, FIG. 4 is provided as an example. Other examples may differ from what is described with regard to FIG. 4.

FIG. 5 is a diagram illustrating an example 500 of a two-step random access procedure associated with SDT, in accordance with the present disclosure. As shown in FIG. 5, a network node 110 and a UE 120 may communicate with one another to perform an SDT two-step random access procedure. In some examples, the SDT two-step random access procedure may be associated with an RA-SDT configuration, such as an uplink RA-SDT configuration or a downlink RA-SDT configuration.

As shown by reference number 505, the network node 110 may transmit, and the UE 120 may receive, an RRC release communication (e.g., an RRCRelease). The RRC release communication may be an RRCRelease with suspendConfig communication. In some examples, the RRC release communication may indicate a RA-SDT configuration. For example, the RRC release communication may indicate an uplink (or MO) RA-SDT configuration to be used by the UE 120 to initiate uplink SDTs (e.g., while the UE 120 is operating in an RRC inactive mode). Additionally, or alternatively, the RRC release communication may indicate a downlink (or MT) RA-SDT configuration to be used for MT-SDTs (e.g., while the UE 120 operating in an RRC inactive mode). As shown by reference number 510, the UE 120 may transition to an RRC inactive mode based on receiving the RRC release communication.

For example, for traditional (e.g., non-SDT) random access configurations, the network node 110 may transmit, and the UE 120 may receive, one or more synchronization signal blocks (SSBs) and random access configuration information. In some examples, the random access configuration information (e.g., non-SDT random access configuration information) may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

In some examples, as shown by reference number 515, the network node 110 may transmit, and the UE 120 may receive, a paging communication. For example, the UE 120 may receive the paging communication for MT-SDT procedures. The paging communication may indicate that the network (e.g., the network node 110) has downlink data to be transmitted to the UE 120. In some examples, the paging communication may include an SDT indication (e.g., indicating that the downlink data is associated with a downlink, or MT, SDT procedure). In some examples, the paging communication may include an indication of a preamble dedicated for the SDT random access procedure.

As shown by reference number 520, the UE 120 may transmit, and the network node 110 may receive, a RAM preamble. As shown by reference number 525, the UE 120 may transmit, and the network node 110 may receive, a RAM payload. As shown, the UE 120 may transmit the RAM preamble and the RAM payload to the network node 110 as part of an initial (or first) step of the SDT two-step random access procedure. In some examples, the RAM may be referred to as message A, msgA, a first message, or an initial message in a two-step random access procedure. Furthermore, in some examples, the RAM preamble may be referred to as a message A preamble, a msgA preamble, a preamble, or a PRACH preamble, and the RAM payload may be referred to as a message A payload, a msgA payload, or a payload. In some examples, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

In some examples, the RAM payload may include an RRC resume request communication (e.g., RRCResumeRequest). In some examples, the RAM payload may include uplink data. In some examples, the RAM payload may include a buffer status report (BSR) associated with the UE 120. For example, the BSR may be included in a medium access control (MAC) control element (MAC-CE).

In some examples, the RA-SDT procedure may be associated with UE context relocation. For example, a first network node 110 that receives the RAM payload may be different than a second network node 110 that transmits the RRC release communication (e.g., as described above in connection with reference number 505). In examples of RA-SDT with UE context relocation, the first network node 11—may communicate with the second network node 110 to obtain UE context information associated with the UE 120. For example, the UE context information may include information to establish a communication connection with a RAN, such as protocol data unit (PDU) session context, a security key, a mobility restriction, and/or a UE capability, among other examples. The first network node 110 may store the UE context information associated with the UE 120 based on the UE 120 transitioning to the RRC inactive mode, as described above. The second network node 110 may transmit, and the first network node 110 may receive, a retrieve UE context request (e.g., based on the second network node 110 receiving the RAM payload). The first network node 110 may transmit, and the second network node 110 may receive, a retrieve UE context response communication indicating the UE context information. The second network node 110 may communicate with one or more core network nodes (e.g., an access and mobility function (AMF) or a user plane function (UPF)) to establish a connection associated with the UE 120.

In other examples, the first network node 110 may keep the UE context information. In such examples, the first network node 110 may transmit, and the second network node may receive, a partial UE context transfer communication (e.g., in response to the retrieve UE context request). The second network node 110 may establish an SDT RLC entity for communicating with the UE 120 based on information included in the partial UE context transfer communication. The first network node 110 may keep a PDCP entity associated with the UE 120 at the first network node 110.

As shown by reference number 530, the network node 110 may receive the RAM preamble transmitted by the UE 120. If the network node 110 successfully receives and decodes the RAM preamble, the network node 110 may then receive and decode the RAM payload.

As shown by reference number 535, the network node 110 may transmit an RAR (sometimes referred to as an RAR message). As shown, the network node 110 may transmit the RAR message as part of a second step of the two-step random access procedure. In some examples, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As part of the second step of the two-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication. In an RA-SDT procedure, the RAR may not include an RRC communication or RRC information. For example, the RAR may indicate contention resolution information for the SDT procedure, but may not cause the UE 120 to transition out of the RRC inactive mode. In other words, after the receiving the RAR, the UE 120 may remain in the RRC inactive mode.

As shown by reference number 540, as part of the second step of the two-step random access procedure, the network node 110 may transmit the PDSCH communication for the RAR, as scheduled by the PDCCH communication. The RAR may be included in a MAC PDU of the PDSCH communication. In some examples, as shown by reference number 545, if the UE 120 successfully receives the RAR, the UE 120 may transmit a hybrid automatic repeat request (HARQ) acknowledgement (ACK).

As shown in FIG. 5, based on performing the RA-SDT procedure, the UE 120 may be enabled to transmit uplink SDTs and/or receive MT-SDTs. For example, as shown by reference number 550, for an MO-SDT procedure (e.g., an MO-SDT), if the UE 120 successfully receives the RAR, the UE 120 may transmit uplink data (e.g., uplink small data having a size that is less than or equal to an MO-SDT threshold). As shown by reference number 555, the network node 110 may transmit, and the UE 120 may receive, downlink data (e.g., downlink small data having a size that is less than or equal to a MT-SDT threshold) that is in response to the uplink data. Alternatively, for a MT-SDT procedure (e.g., MT-SDT), the network node 110 may transmit the downlink data to the UE 120 after transmitting the RAR. For example, the downlink data may be scrambled with a C-RNTI. The C-RNTI may be indicated via the RAR. The UE 120 may decode the downlink data using the C-RNTI.

As shown in FIG. 5, the UE 120 and the network node 110 may continue to exchange SDT communications. As shown by reference number 560, to end a session associated with the SDT procedure, the network node 110 may transmit, and the UE 120 may receive, an RRC release communication. The RRC release communication may be an RRCRelease with suspendConfig communication. The RRC release communication may cause the UE 120 to release or suspend the RA-SDT configuration used for the random access procedure described above.

As indicated above, FIG. 5 is provided as an example. Other examples may differ from what is described with regard to FIG. 5.

FIG. 6 is a diagram illustrating an example 600 of a four-step random access procedure associated with SDT, in accordance with the present disclosure. As shown in FIG. 6, a network node 110 and a UE 120 may communicate with one another to perform an SDT four-step random access procedure. In some examples, the SDT four-step random access procedure may be associated with an RA-SDT configuration, such as an uplink RA-SDT configuration or a downlink RA-SDT configuration.

As shown by reference number 605, the network node 110 may transmit, and the UE 120 may receive, an RRC release communication (e.g., an RRCRelease). The RRC release communication may be an RRCRelease with suspendConfig communication. In some examples, the RRC release communication may indicate a RA-SDT configuration. For example, the RRC release communication may indicate an uplink (or MO) RA-SDT configuration to be used by the UE 120 to initiate uplink SDTs (e.g., while the UE 120 is operating in an RRC inactive mode). Additionally, or alternatively, the RRC release communication may indicate a downlink (or MT) RA-SDT configuration to be used for MT-SDTs (e.g., while the UE 120 operating in an RRC inactive mode). As shown by reference number 610, the UE 120 may transition to an RRC inactive mode based on receiving the RRC release communication.

For example, for traditional (e.g., non-SDT) random access configurations, the network node 110 may transmit, and the UE 120 may receive, one or more SSBs and random access configuration information. In some examples, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR. In some examples, the RA-SDT procedure may or may not be associated with UE context relocation, as described above in more detail in connection with FIG. 5.

In some examples, as shown by reference number 615, the network node 110 may transmit, and the ULE 120 may receive, a paging communication. For example, the UE 120 may receive the paging communication for MT-SDT procedures. The paging communication may indicate that the network (e.g., the network node 110) has downlink data to be transmitted to the UE 120. In some examples, the paging communication may include an SDT indication (e.g., indicating that the downlink data is associated with a downlink, or MT, SDT procedure). In some examples, the paging communication may include an indication of a preamble dedicated for the SDT random access procedure.

As shown by reference number 620, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 625, the network node 110 may transmit an RAR as a reply to the preamble. The message that includes the RAR may be referred to as message 2, msg2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 630, the UE 120 may transmit an uplink communication. For example, the uplink communication may be an RRC connection request message. The uplink communication message may be referred to as message 3, msg3, MSG3, or a third message of an SDT four-step random access procedure. In some examples, the uplink communication request may include a UE identifier, UCI, and/or a PUSCH communication (e.g., an RRC connection request). In some examples, the uplink communication may include an RRC resume request communication (e.g., RRCResumeRequest). In some examples, the uplink communication may include uplink data. In some examples, the uplink communication may include a BSR associated with the UE 120. For example, the BSR may be included in a MAC-CE.

As shown by reference number 635, the network node 110 may transmit a response. The response may be referred to as message 4, msg4, MSG4, or a fourth message of an SDT four-step random access procedure. In some examples, the response may include the detected UE identifier, a timing advance value, and/or contention resolution information. In an RA-SDT procedure, the response may not include an RRC communication or RRC information. For example, the response may indicate contention resolution information for the SDT procedure, but may not cause the UE 120 to transition out of the RRC inactive mode. In other words, after the receiving the response, the UE 120 may remain in the RRC inactive mode. In some examples, as shown by reference number 640, if the UE 120 successfully receives the RRC connection setup message, the UE 120 may transmit a HARQ ACK.

As shown in FIG. 6, based on performing the RA-SDT procedure, the UE 120 may be enabled to transmit uplink SDTs and/or receive MT-SDTs. For example, as shown by reference number 645, for an MO-SDT procedure (e.g., an MO-SDT), if the UE 120 successfully receives the response, then the UE 120 may transmit uplink data (e.g., uplink small data having a size that is less than or equal to an MO-SDT threshold). As shown by reference number 650, the network node 110 may transmit, and the UE 120 may receive, downlink data (e.g., downlink small data having a size that is less than or equal to a MT-SDT threshold) that is in response to the uplink data. Alternatively, for a MT-SDT procedure (e.g., MT-SDT), the network node 110 may transmit the downlink data to the UE 120 after transmitting the response. For example, the downlink data may be scrambled with a C-RNTI. The C-RNTI may be indicated via the RAR. The UE 120 may decode the downlink data using the C-RNTI.

As shown in FIG. 6, the UE 120 and the network node 110 may continue to exchange SDT communications. As shown by reference number 655, to end a session associated with the SDT procedure, the network node 110 may transmit, and the UE 120 may receive, an RRC release communication. The RRC release communication may be an RRCRelease with suspendConfig communication. The RRC release communication may cause the UE 120 to release or suspend the RA-SDT configuration used for the random access procedure described above.

As indicated above, FIG. 6 is provided as an example. Other examples may differ from what is described with regard to FIG. 6.

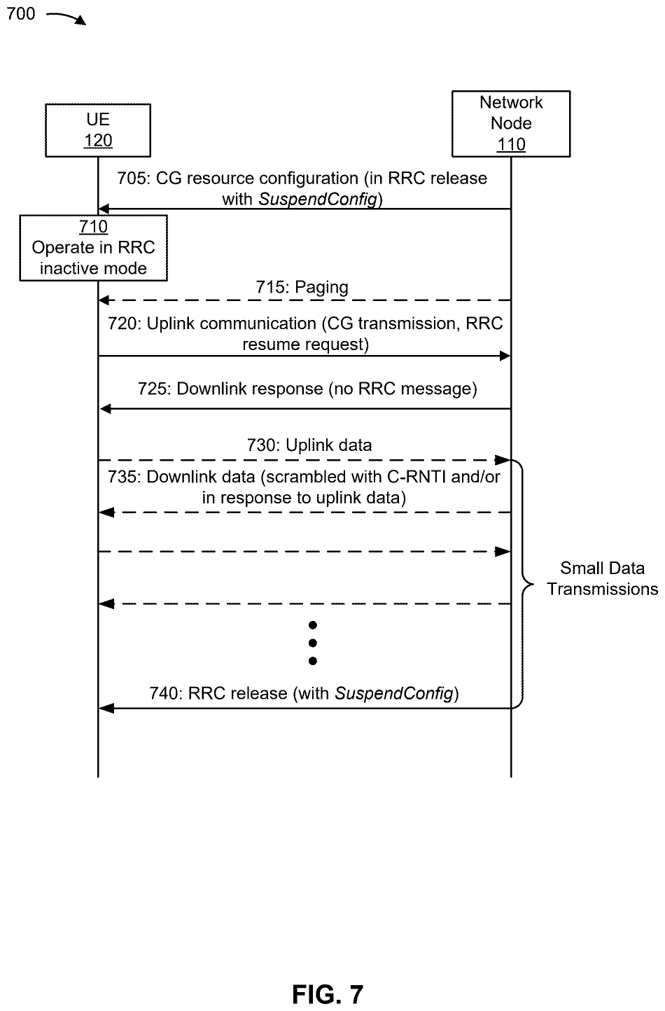

FIG. 7 is a diagram illustrating an example 700 of a CG-SDT procedure, in accordance with the present disclosure. As shown in FIG. 7, a network node 110 and a UE 120 may communicate with one another to perform the CG-SDT procedure. CG communications may include periodic uplink communications that are configured for the UE 120, such that the network node 110 does not need to send separate DCI to schedule each uplink communication, thereby conserving signaling overhead. In some examples, the CG-SDT procedure may be associated with a CG-SDT configuration, such as an uplink CG-SDT configuration or a downlink CG-SDT configuration.

As shown by reference number 705, the network node 110 may transmit, and the UE 120 may receive, a CG-SDT configuration. For example, the CG-SDT configuration may indicate a resource configuration for the CG-SDT procedure. In some examples, the CG-SDT configuration may be included in an RRC release communication, such as an RRC release with SuspendConfig communication. The CG-SDT configuration identifying a SDT CG may indicate a resource allocation (e.g., in a time domain, frequency domain, spatial domain, and/or code domain) and/or a periodicity associated with the resource allocation. The SDT CG may identify a resource or set of resources available to the UE 120 for transmission of an SDT uplink communication (e.g., data and/or control information). For example, the CG-SDT configuration may identify a resource allocation for a PUSCH. In some aspects, the CG-SDT configuration may identify a resource pool or multiple resource pools that may be available to the UE 120 for an uplink transmission.

In some aspects, the CG-SDT configuration may configure contention-free SDT CG communication with resources dedicated for the UE 120 to transmit SDT uplink communications. In such examples, the CG-SDT configuration may indicate a resource allocation (e.g., in a time domain, frequency domain, spatial domain, and/or code domain) dedicated for the UE 120 to use to transmit SDT uplink communications. As shown by reference number 710, the UE 120 may transition to an RRC inactive mode based on receiving the RRC release communication.

In some examples, as shown by reference number 715, the network node 110 may transmit, and the ULE 120 may receive, a paging communication. For example, the UE 120 may receive the paging communication for MT-SDT procedures. The paging communication may indicate that the network (e.g., the network node 110) has downlink data to be transmitted to the UE 120. In some examples, the paging communication may include an SDT indication (e.g., indicating that the downlink data is associated with a downlink, or MT, SDT procedure).

As shown by reference number 720, the UE 120 may transmit, and the network node 110 may receive, an MO-SDT communication using a CG indicated by the CG-SDT configuration. In some examples, the MO-SDT communication may be in response to the paging communication (e.g., in MT-SDT procedures). In other examples, the UE 120 may transmit the MO-SDT communication based on having uplink data to transmit to the network node 110. In some examples, the MO-SDT communication may include an RRC resume request communication.

As shown by reference number 725, the network node 110 may transmit, and the UE 120 may receive, a downlink communication in response to the MO-SDT communication. In some examples, the downlink communication may include an ACK of the MO-SDT communication. In other examples, the downlink communication may request a retransmission of the MO-SDT communication. In some examples, such as in a MT-SDT procedure, the downlink communication may include a grant (e.g., a dynamic grant) scheduling a SDT downlink communication. For example, the downlink communication may include an indication of a C-RNTI to be associated with future SDT downlink communications. In a CG-SDT procedure, the downlink communication may not include an RRC communication or RRC information. For example, the downlink communication may not cause the UE 120 to transition out of the RRC inactive mode. In other words, after the receiving the downlink communication, the UE 120 may remain in the RRC inactive mode

As shown in FIG. 7, the UE 120 may be enabled to transmit uplink SDTs and/or receive MT-SDTs. For example, as shown by reference number 730, for an MO-SDT procedure (e.g., an MO-SDT), if the UE 120 successfully receives the downlink communication from the network node 110, then the UE 120 may transmit uplink data (e.g., uplink small data having a size that is less than or equal to an MO-SDT threshold). As shown by reference number 735, the network node 110 may transmit, and the UE 120 may receive, downlink data (e.g., downlink small data having a size that is less than or equal to a MT-SDT threshold) that is in response to the uplink data. Alternatively, for a MT-SDT procedure (e.g., MT-SDT), the network node 110 may transmit the downlink data to the UE 120 after transmitting the response (e.g., as scheduled by the grant included in the downlink communication). For example, the downlink data may be scrambled with the C-RNTI. The UE 120 may decode the downlink data using the C-RNTI.

As shown in FIG. 7, the UE 120 and the network node 110 may continue to exchange SDT communications. As shown by reference number 740, to end a session associated with the SDT procedure, the network node 110 may transmit, and the UE 120 may receive, an RRC release communication. The RRC release communication may be an RRCRelease with suspendConfig communication. The RRC release communication may cause the UE 120 to release or suspend the CG-SDT configuration used for the random access procedure described above.

As indicated above, FIG. 7 is provided as an example. Other examples may differ from what is described with regard to FIG. 7.

As described above, RA-SDT procedures with or without UE context relocation may be support. Further, a UE 120 may be configured with both MO-SDTconfigurations and MT-SDT configurations. Additionally, SDT configurations may be associated with different types of configurations (e.g., RA-SDT configurations (e.g., with or without UE context relocation) or CG-SDT configurations). Each type of configuration may be associated with respective (e.g., different) limitations or restrictions. For example, CG resources for SDT may only be used by a UE 120 within a cell in which the UE 120 received an RRC release communication and transitioned to the RRC inactive mode.

Additionally, the UE 120 may be triggered to receive MT-SDT communications via a paging communication that includes an SDT indication (e.g., an MT-SDT indication). However, the UE 120 may not expect to receive the MT-SDT communication in the paging communication. The UE 120 may respond to the paging communication via an uplink communication and may expect to receive the MT-SDT communication(s) in response to the uplink communication. However, the UE 120 may be enabled to use either an RA-SDT procedure or a CG-SDT procedure to respond to the paging communication. As a result, it may be unclear under what conditions or in what scenarios the UE 120 is to use a given SDT procedure for responding to a paging communication that includes an SDT indication.

Moreover, the UE 120 may receive paging communication that includes an SDT indication from any network node 110 that is geographically located within a RAN notification area (RNA). The RNA may also be referred to as a paging area. For example, the UE 120 may receive paging communications triggering MT-SDT procedures from multiple network nodes within a given RNA. As a result, it may be unclear to the UE 120 what SDT uplink resource and/or SDT configuration to use to respond to a paging communication from a given network node 110.

Some techniques and apparatuses described herein enable resource configuration and selection for downlink small data transmissions. For example, the UE 120 may receive, from a network node 110, an indication that the UE 120 is to perform a MT-SDT operation (e.g., the indication may be included in a paging communication). The UE 120 may transmit, to the network node 110, an uplink communication in response to the indication (e.g., in response to the paging communication). The uplink communication may use a first uplink resource associated with an MO-SDT configuration (e.g., a MO RA-SDT configuration or a MO CG-SDT configuration) based at least in part on one or more conditions being satisfied. Alternatively, the uplink communication may use a second uplink resource associated with a random access configuration (e.g., a non-SDT random access configuration) based at least in part on the one or more conditions not being satisfied or based at least in part on no MO-SDT configurations being configured for the UE 120.

As an example, the uplink communication may use a resource associated with a CG MO-SDT configuration (e.g., referred to herein as a CG-SDT configuration in some cases) based at least in part on a first one or more conditions, from the one or more conditions, being satisfied. The uplink communication may use a resource associated with a random access SDT configuration based at least in part on the first one or more conditions not being satisfied and based at least in part on a second one or more conditions, from the one or more conditions, being satisfied. The uplink communication may use a resource associated with the random access configuration based at least in part on the first one or more conditions and the second one or more conditions not being satisfied.

As a result, conditions may be defined for the use of various MO-SDT configurations to be used to respond to a paging communication triggering a MT-SDT procedure. This may improve an efficiency of resource utilization because the UE 120 may be enabled to use resources configured for MO-SDT procedures to respond to the paging communication triggering a MT-SDT procedure (e.g., thereby not requiring additional resources to be configured or allocated for the MT-SDT procedure). Additionally, this may reduce a signaling overhead, latency, and/or power consumption that would have otherwise been associated with the MT-SDT procedure due to the configuration and/or use of additional resources (e.g., to be used by the UE 120 to respond to the paging communication). Further, this may improve a mobility and enhance a wireless communication coverage for SDT receptions and/or transmissions by defining the use of various MO-SDT configurations to be used when different network nodes 110 trigger a MT-SDT operation.

FIG. 8 is a diagram of an example 800 associated with resource configuration and selection for downlink small data transmissions, in accordance with the present disclosure. As shown in FIG. 8, one or more network nodes (e.g., one or more network nodes 110) may communicate with a UE (e.g., a UE 120). In some aspects, the network node(s) 110 and the UE 120 may be part of a wireless network (e.g., the wireless network 100). In some aspects, actions described as being performed by the network node 110 may be performed by multiple different network nodes. For example, configuration actions may be performed by a first network node (e.g., a CU and/or a DU), and radio communication actions may be performed by a second network node (e.g., a DU and/or an RU). The UE 120 and the network node 110 may have established a wireless connection prior to operations shown in FIG. 8.

In some aspects, as shown by reference number 805, the UE 120 may transmit (e.g., using transmission component 1104, communication manager 140, controller/processor 280, transmit processor 264, TX MIMO processor 266, MOD 254, antenna 252, and/or memory 282), and the network node 110 may receive (directly or via one or more other network nodes), a capability report. In some aspects, the capability report may indicate UE support for performing SDT procedures. For example, the capability report may indicate that the UE 120 supports performing MO-SDT communications and/or MT-SDT communications. In some aspects, the UE 120 may be configured to perform MO-SDT communications and/or MT-SDT communications, as described in more detail elsewhere herein, based at least in part on transmitting the capability report. In some aspects, the UE capability report may be included in a UE assistance information (UAI) communication. The UAI communication may indicate mobility information (e.g., indicating whether the UE is moving or is stationary), among other examples.

As shown by reference number 810, the network node 110 may transmit (e.g., using communication manager 150, transmission component 1204, controller/processor 240, transmit processor 220, TX MIMO processor 230, MOD 232, antenna 234, and/or memory 242) (directly or via one or more other network nodes), and the ULE 120 may receive, configuration information. In some aspects, the UE 120 may receive the configuration information via one or more of system information (SI) signaling (e.g., via one or more SIBs), RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE is to select an uplink resource to respond to a paging communication triggering a MT-SDT procedure (e.g., an MT SDT procedure) from resources associated with an MO-SDT configuration or from resources associated with a RACH configuration (e.g., a non-SDT random access configuration). In some aspects, the configuration information may indicate one or more conditions (or values for threshold(s) associated with the one or more conditions) to be used by the UE 120 to determine which configuration is to be associated with the response to the paging communication. In some other aspects, the one or more conditions (or values for threshold(s) associated with the one or more conditions) may be defined, or otherwise fixed, by a wireless communication standard, such as the 3GPP (e.g., and not signaled to the UE 120).

For example, the configuration information may indicate a first one or more conditions associated with selecting a resource associated with an uplink CG-SDT configuration, a second one or more conditions associated with selecting a resource associated with an uplink RA-SDT configuration, and/or a third one or more conditions associated with selecting a resources from a random access configuration, among other examples. In some aspects, the configuration information may indicate a priority order associated with different uplink configurations to be used for responding to a paging communication triggering a MT-SDT procedure. For example, the configuration information may indicate that the UE 120 is to first attempt to select a resource from the uplink CG-SDT configuration (e.g., because these resources may be dedicated to the UE 120 and a timing alignment with the network node 110 may already be established). The configuration information may indicate that if the UE 120 is unable to (or not allowed to) select a resource from the CG-SDT configuration (e.g., because the first one or more conditions are not satisfied), then the UE 120 is to attempt to select a resource from the uplink RA-SDT configuration. The configuration information may indicate that if the UE 120 is unable to (or not allowed to) select a resource from the RA-SDT configuration (e.g., because the second one or more conditions are not satisfied), then the UE 120 is to attempt to select a resource from the random access configuration. The conditions described above are described in more detail elsewhere herein.

In some aspects, the configuration information may indicate the uplink CG-SDT configuration, the uplink RA-SDT configuration, and/or the random access configuration. The uplink RA-SDT configuration may include a two-step SDT random access configuration and/or a four-step SDT random access configuration. Similarly, the random access configuration may include a two-step random access configuration and/or a four-step random access configuration.

In some aspects, the configuration information may include configuration information associated with a MT-SDT operation or procedure. For example, the configuration information may indicate resources (e.g., downlink and/or uplink resources) that are associated with the MT-SDT operation. In some aspects, the configuration information may indicate one or more parameters (e.g., power control parameters, timing control parameters, and/or other communication parameters) associated with the MT-SDT operation. The configuration information may associated with at least one of system information signaling, radio resource control signaling, MAC-Ce signaling, and/or downlink control information signaling, among other examples. In other words, downlink and uplink resource configurations for a MT-SDT configuration can be signaled by the network node 110 via SI, RRC, MAC-CE, and/or DCI, among other examples.

In some aspects, the configuration information may indicate that PRACH resources (e.g., PRACH preambles) associated with an MO-SDT configuration are to be associated with the MT-SDT operation. For example, the configuration information may indicate that PRACH resources configured for an RA-SDT procedure can be shared with PRACH resources configured for an MT-SDT procedure.

In some aspects, the configuration information may include information associated with one or more timers associated with the MT-SDT operation (e.g., the MT-SDT procedure). The one or more timers may include an SDT timing alignment timer, a session timer for MT-SDT sessions, a failure detection timer, an inactivity timer, and/or other SDT-specific timers described herein. The information associated with one or more timers (e.g., durations of the one or more timers) may be indicated to the UE 120 via RRC signaling, MAC-CE signaling, and/or DCI signaling, among other examples. For example, the one or more timers may be dedicated for the UE 120 (e.g., may be specific to the UE 120). Therefore, SI signaling may not be used to indicate the information associated with one or more timers. In some aspects, the information associated with one or more timers is associated with at least one of a reference SSB (synchronization and PBCH block) or other downlink reference signal used for tracking loops and measurements, a set of thresholds for timer validation, an indication for the timing differences between serving network nodes of UE 120, a message or a set of criteria triggering UE 120 to report the assistance information for timing control, and/or mobility management and measurement relaxation, among other examples.

In some aspects, the configuration information may indicate power control information for uplink communications associated with the MT-SDT operation. The power control information may be associated with closed-loop power control and/or open-loop power control. For example, power control (e.g., closed-loop and/or open-loop) procedures may be supported for uplink transmissions of an MT-SDT procedure. Information associated with the power control procedure may be indicated via the configuration information. For example, the power control information may include a power control command. The UE 120 may receive an indication of the power control command via MAC-CE signaling and/or DCI signaling, among other examples. In some aspects, the configuration information may include open-loop and closed-loop power control information for uplink communications associated with one, or multiple, network nodes 120 supporting the MT-SDT procedure, MO-SDT procedure, and/or RA procedure, associated with the UE 120.

In some aspects, the configuration information may indicate timing control information for uplink communications associated with the MT-SDT operation. For example, the configuration information may indicate that timing control (e.g., closed-loop timing control or open-loop timing control) procedures are supported for uplink transmissions of MT-SDT procedures. As an example, the timing control information may include a timing advance command. The UE 120 may receive the timing advance command via MAC-CE signaling, or DCI signaling. As another example, the timing control information may include a system frame timing difference (SFTD) between the network node 110 and one or more other or more other network nodes (e.g., between a serving network node 110 of the ULE 120 and neighbor network nodes 110). The UE 120 may receive indication of the SFTD via unicast signaling, multicast signaling, and/or broadcast signaling.

In some aspects, the configuration information may include open-loop and closed-loop timing control information for DL and UL communications associated with one, or multiple, network nodes 120 supporting the MT-SDT procedure, the MO-SDT procedure, and/or a random access procedure, associated with the UE 120. In some aspects, the timing control information may include an indication of a timing advance command, a configuration for reference SSB (synchronization and PBCH block) or other DL RS used for tracking loops and measurements, information for timing control associated with multiple serving network nodes of the UE 120, a message or a set of criteria triggering UE to report the timing advance information, and/or a message or a set of criteria triggering UE to report assistance information for timing control, mobility management and measurement relaxation, among other examples.

In some aspects, the configuration information may include a pathloss reference signal configuration. A change of one or more pathloss reference signal configurations associated with the MT-SDT operation can be signaled to the UE 120. For example, the UE 120 may receive a pathloss reference signal configuration and/or a modification to the pathloss reference signal configuration via RRC signaling, MAC-CE signaling, and/or DCI signaling.

In some aspects, the configuration information indicates a reduced radio resource management (RRM) measurement configuration for the MT-SDT operation. The reduced RRM measurement configuration may also be referred to as RRM measurement relaxation. For example, the reduced RRM measurement configuration may be associated with longer intervals between measurements (e.g., longer intervals for a Tdetect parameter, a Tevaluate parameter, and/or a Tmeasure parameter) and/or different thresholds or requirements for intra-frequency and/or inter-frequency neighbor cell measurements, among other examples. The RRM measurement relaxation may enable the UE 120 to conserve power associated with the MT-SDT operation. In some aspects, the UE 120 may be configured with the reduced RRM measurement configuration based at least in part on transmitting the UAI communication. For example, the UAI communication (e.g., as described above in connection with reference number 805) may indicate mobility information associated with the UE 120. The UE 120 may be configured with the reduced RRM measurement configuration for MT-SDT in low mobility scenarios and/or when the UE 120 is not located near a geographic edge of a cell (e.g., as indicated by the UAI communication).

In some aspects, the configuration information may indicate a reduced downlink control channel monitoring (e.g., PDCCH monitoring) or reduced timeline configuration. For example, the UE 120 may be configured with reduced PDCCH monitoring (e.g., PDCCH skipping and/or search space set group (SSSG) switching) and/or timeline relaxation (cross-slot scheduling with a k0 parameter having a value greater than one) for MT-SDT procedures. The UE 120 may receive an indication of the reduced downlink control channel monitoring or the reduce timeline configuration via RRC signaling, MAC-CE signaling, and/or DCI signaling. For example, the reduced PDCCH monitoring or timeline relaxation can be configured for the UE 120 (e.g., that is capable of MT-SDT) via RRC signaling, MAC-CE signaling, and/or DCI signaling (e.g., with or without the UE 120 transmitting UAI).

In some aspects, the configuration information may indicate semi-persistent scheduling (SPS) or semi-static resources for a downlink channel (e.g., for a PDSCH) associated with the MT-SDT operation based at least in part on one or more conditions being satisfied. For example, due to a mobility status of the UE 120 changing within an RNA of the UE 120, SPS or semi-static resource allocations for PDSCH may not be configured or activated for MT-SDT unless the one or more conditions are satisfied. In some aspects, SPS or semi-static resource allocations for PDSCH may not be configured or activated for MT-SDT unless all of the one or more conditions are satisfied. In other examples, SPS or semi-static resource allocations for PDSCH may not be configured or activated for MT-SDT unless a certain quantity or a certain combination of conditions are satisfied.

The one or more conditions associated with SPS or semi-static resource allocations for the PDSCH being configured or activated for MT-SDT may include a first condition associated with whether an uplink communication is successfully transmitted by the UE 120 and/or received by the UE 120. For example, the first condition may be satisfied if an RRC resume request communication transmitted by the UE 120 is received by the network node 110 (e.g., an RRC resume request in response toa paging communication triggering the MT-SDT operation). The one or more conditions associated with SPS or semi-static resource allocations for the PDSCH being configured or activated for MT-SDT may include a second condition associated with whether mobility information and a link status associated with the UE 120 is reported to the network node 110. For example, the second condition may be satisfied if the UE 120 transmits a mobility status and a link quality (e.g., indicating that the UE 120 is associated with low mobility and is not located at a cell edge) to the network node 110. For example, if the mobility status of the UE 120 indicates high mobility and/or a link quality (e.g., an RSRP measurement) is less than a cell edge threshold, then the second condition may not be satisfied.

The one or more conditions associated with SPS or semi-static resource allocations for the PDSCH being configured or activated for MT-SDT may include a third condition associated with whether a paging communication and any subsequent downlink communications associated with the MT-SDT operation are received from the network node 110 (e.g., and not another network node 110). For example, the third condition may be satisfied if a paging indication for MT-SDT, MT-SDT message(s), and subsequent downlink messages are transmitted by the (same) network node 110. The one or more conditions associated with SPS or semi-static resource allocations for the PDSCH being configured or activated for MT-SDT may include a fourth condition associated with whether a measurement value of a downlink reference signal (e.g., a reference SSB or another reference signal) satisfies an SPS threshold (e.g., an RSRPThreshold-sps). For example, fourth condition may be associated with an RSRP of a downlink pathloss reference signal satisfying a pre-configured RSRPThreshold-sps threshold (e.g., that is indicated to the UE 120 by the network node 110).

The one or more conditions associated with SPS or semi-static resource allocations for the PDSCH being configured or activated for MT-SDT may include a fifth condition associated with whether the UE 120 is configured with uplink resources (e.g., valid uplink resources), for providing HARQ feedback associated with the MT-SDT operation, that occur prior to an expiration of an SDT timing alignment timer and/or a HARQ RTT. For example, the fifth condition may be satisfied if the UE 120 is configured with valid uplink resources to transmit the HARQ feedback for MT-SDT and subsequent downlink messages before a SDT-specific timing alignment timer expires. The SDT-specific timing alignment timer may control an amount of time that a timing alignment between the UE 120 and the network node 110 is valid (e.g., after the UE 120 receives an RRC release with SuspendConfig communication). The one or more conditions associated with SPS or semi-static resource allocations for the PDSCH being configured or activated for MT-SDT may include a sixth condition associated with whether an SDT timer, that is initiated after an initial transmission of the MT-SDT operation, has expired. The SDT timer may be referred to as an SDT error detection timer. The SDT timer may control a duration of the MT-SDT operation and may be initiated after the UE 120 received an initial transmission or reception associated with the MT-SDT operation. If the SDT timer has not expired, then the sixth condition may be satisfied. If the time has expired, then the sixth condition may not be satisfied. The one or more conditions associated with SPS or semi-static resource allocations for the PDSCH being configured or activated for MT-SDT may include a seventh condition associated with whether the serving network node for SPS or semi-static MT-SDT communications is the network node in an RNA of the UE from which UE received the RRC release message and transitioned to RRC inactive state to perform the MT-SDT procedure.

The UE 120 may configure itself based at least in part on the configuration information. In some aspects, the UE 120 may be configured to perform one or more operations described herein based at least in part on the configuration information.

As shown by reference number 815, the network node 110 may transmit (e.g., using communication manager 150, transmission component 1204, controller/processor 240, transmit processor 220, TX MIMO processor 230, MOD 232, antenna 234, and/or memory 242), and the ULE 120 may receive (e.g., using communication manager 140, reception component 1102, antenna 252, DEMOD 254, MIMO detector 256, receive processor 258, controller/processor 280, and/or memory 282), an RRC release communication. The RRC release communication may be an RRC release with SuspendConfig communication. As described in more detail elsewhere herein, the RRC release communication may indicate one or more MO-SDT configurations, such as an uplink CG-SDT configuration and/or an uplink RA-SDT configuration, among other examples. In some aspects, the RRC release communication may indicate some, or all, of the configuration information described above. The network node 110 that transmits the RRC release communication may be referred to herein as an “anchor” network node 110 for the UE 120.

As shown by reference number 820, the UE 120 may transition to the RRC inactive mode based at least in part on receiving the RRC release communication. For example, for operations described below, the UE 120 may be operating in the RRC inactive mode. In some aspects, for operations described below, the UE 120 may be operating in the RRC idle mode.

As shown by reference number 825, the UE 120 may receive (e.g., using communication manager 140, reception component 1102, antenna 252, DEMOD 254, MIMO detector 256, receive processor 258, controller/processor 280, and/or memory 282), and the network node 110 (or another network node 110) may transmit, an indication that the UE 120 is to perform a MT-SDT operation (e.g., an MT-SDT operation). For example, the indication that the UE 120 is to perform the MT-SDT operation may be included in a paging signal. For example, the paging signal may include an SDT indication (e.g., an indication that the MT-SDT operation is to be performed). For example, the paging signal may indicate to the UE 120 that the network node 110 has downlink data to transmit to the UE 120. The SDT indication may indicate that the UE 120 is to perform the MT-SDT operation to receive the downlink data (e.g., that the UE 120 is to remain in the RRC inactive mode while receiving the downlink data). The network node 110 that transmits the paging signal may be referred to herein as a “serving” network node 110. In some aspects, the anchor network node 110 and the serving network node 110 may be the same network node 110 (or may be associated with the same DU or CU). In other aspects, the anchor network node 110 and the serving network node 110 may be different network nodes 110.

As shown by reference number 830, the UE 120 may select (e.g., using communication manager 140, resource selection component 1108, controller/processor 280 and/or memory 282) one or more uplink resources to be used by the UE 120 to transmit uplink communications associated with the MT-SDT operation. For example, the uplink communications may include an RRCResumeRequest communication, an indication of a UE identifier of the UE 120, one or more uplink communications (e.g., MO-SDT communications, UAI, MAC-CE including a BSR, a power headroom report (PHR), and/or a channel state information (CSI) report), and/or uplink responses to downlink communications (e.g. UCI, and/or MAC-CE), among other examples.

For example, as described above, the UE 120 may be configured with CG-SDT resources, such as CG PUSCH resources, DMRS resources, and/or physical uplink control channel (PUCCH) resources, among other examples. Additionally, or alternatively, the UE 120 may be configured with RA-SDT resources, such as resources for a msg1/msg3 of four step RACH procedure, resources for a msgA/msg3 fallback of two step RACH procedure, and/or PUCCH resources, among other examples. Additionally, or alternatively, the UE 120 may be configured with resources for a RACH procedure (e.g., a non-SDT RACH procedure). In some aspects, PRACH resources supporting two step RACH procedures (RA-SDT and/or non-SDT RACH) and four step RACH procedures (RA-SDT and/or non-SDT RACH) can be shared or may separately configured for the UE 120. The UE 120 may select resources, from the CG-SDT resources. The RA-SDT resources, or the RACH procedure resources, based at least in part on whether one or more conditions are satisfied.

In some aspects, the UE 120 may select a first uplink resource associated with an MO-SDT configuration (e.g., CG-SDT or RA-SDT) based at least in part on one or more conditions being satisfied. The UE 120 may select a second uplink resource associated with a random access configuration based at least in part on the one or more conditions not being satisfied or based at least in part on no MO-SDT configurations being configured for the UE 120. In some aspects, the UE 120 may select resources to be associated with the MT-SDT operation from the CG-SDT (e.g., a CG MO-SDT configuration) based at least in part on a first one or more conditions, from the one or more conditions, being satisfied. The UE 120 may select resources to be associated with the MT-SDT operation from the RA-SDT (e.g., a random access SDT configuration) based at least in part on the first one or more conditions not being satisfied and based at least in part on a second one or more conditions, from the one or more conditions, being satisfied. The UE 120 may select resources to be associated with the MT-SDT operation from the random access configuration based at least in part on the first one or more conditions and the second one or more conditions not being satisfied. In some aspects, the UE 120 may select resources to be associated with the MT-SDT operation from the random access configuration based at least in part on a third one or more conditions being satisfied.

In other words, the UE 120 may first attempt to select uplink resources from the CG-SDT configuration. If the UE 120 is unable to select resources from the CG-SDT configuration (or if the UE 120 is not configured with a CG-SDT configuration), then the UE 120 may attempt to select uplink resources from the RA-SDT configuration. If the UE 120 is unable to select resources from the RA-SDT configuration (or if the UE 120 is not configured with a RA-SDT configuration), then the UE 120 may attempt to select uplink resources from the random access configuration (e.g., a non-SDT random access configuration).

For example, if CG-SDT resources are configured on the uplink for a UE 120 in the RRC idle mode of the RRC inactive mode to transmit, the CG-SDT resources will be selected by the UE 120 performing MT-SDT, if the first one or more conditions are satisfied. For example, the first one or more conditions associated with selecting resources from the CG-SDT configuration may include a first condition associated with whether the network node 110 is a serving network node from which the UE 120 received a RRC communication (e.g., the RRC release with SuspendConfig communication) that caused the UE 120 to transition to the RRC inactive mode. For example, the first condition may be associated with whether the serving network node selected by the UE 120 for an SDT (e.g., MO-SDT, MT-SDT, or a combination of MO-SDT and MT-SDT) procedure is a serving network node from which the UE 120 received the RRC release message that caused the UE 120 to transition to the RRC inactive mode. In other words, the first condition may be associated with whether a paging indication for MT-SDT (e.g., as described above in connection with reference number 825), MT-SDT message(s) and subsequent downlink control and/or data messages are transmitted by the network node 110 from which the UE received RRCRelease (e.g., as described above in connection with reference number 815) and transitioned to the RRC inactive mode to perform MT-SDT procedure. For example, if the UE 120 receives the RRC release with SuspendConfig communication and the paging signaling triggering the MT-SDT procedure from the same network node 110, then the first condition may be satisfied. If the UE 120 receives the RRC release with SuspendConfig communication and the paging signaling triggering the MT-SDT procedure from different network nodes 110, then the first condition may not be satisfied.

The first one or more conditions associated with selecting resources from the CG-SDT configuration may include a second condition associated with whether the CG MO-SDT configuration is received from the serving network node. For example, the second condition may be associated with whether CG-SDT resources for the UE are configured by the network node 110 from which the UE received RRCRelease (e.g., as described above in connection with reference number 815) and transitioned to the RRC inactive mode to perform MT-SDT procedure. If the UE 120 receives the configuration for the CG-SDT resources and the RRC release with SuspendConfig communication from the same network node 110, then the second condition may be satisfied. If the UE 120 receives the configuration for the CG-SDT resources and the RRC release with SuspendConfig communication from different network nodes 110, then the second condition may not be satisfied.

The first one or more conditions associated with selecting resources from the CG-SDT configuration may include a third condition associated with whether a data volume of pending uplink data across all SDT radio bearers satisfies one or more uplink data volume thresholds (e.g., a DataVolume Threshold-cg-PUSCH). For example, the third condition may be associated with whether a data volume of pending uplink data across all SDT radio bearers satisfies a set of uplink data volume thresholds associated with MO-SDT and/or MT-SDT. For example, the third condition may be associated with whether the data volume of the pending UL data across all SDT radio bearers is less than or equal to a pre-configured DataVolume Threshold-cg-PUSCH indicated by a serving network node 110. If the data volume satisfies the uplink data volume threshold, then the third condition may be satisfied. If the data volume does not satisfy the uplink data volume threshold, then the third condition may not be satisfied.

The first one or more conditions associated with selecting resources from the CG-SDT configuration may include a fourth condition associated with whether a measurement value of a downlink reference signal (e.g., a reference SSB or another reference signal) satisfies one or more uplink CG thresholds (e.g., RSRPThreshold-cg-PUSCH). For example, the fourth condition may be associated with whether a measurement value of a downlink reference signal satisfies a set of thresholds for link quality evaluation associated with MO-SDT and/or MT-SDT. For example, the fourth condition may be associated with whether an RSRP of a downlink pathloss reference signal is greater than or equal to a pre-configured RSRPThreshold-cg-PUSCH indicated by the serving network node 110. The UE 120 may measure the RSRP of a downlink pathloss reference signal via measurement an SSB, a CSI reference signal (CSI-RS), a tracking reference signal (TRS), a positioning reference signal (PRS), a received signal strength (RSS), a wake-up signal, a low-power wake-up signal, and/or another downlink reference signal transmitted by the serving network node 110. If the RSRP of the downlink reference signal satisfies the uplink CG threshold, then the fourth condition may be satisfied. If RSRP of the downlink reference signal does not satisfy the uplink CG threshold, then the fourth condition may not be satisfied.

The first one or more conditions associated with selecting resources from the CG-SDT configuration may include a fifth condition associated with whether an SDT timing alignment timer is expired. For example, the fifth condition may be associated with whether an SDT timing alignment timer, or a HARQ round-trip time (RTT) timer, or a combination thereof is expired. For example, the fifth condition may be associated with whether an SDT-specific timing alignment timer is valid before initial transmission and retransmission(s) of CG-SDT communications. The SDT timing alignment timer may be associated with an amount of time that a timing alignment between the UE 120 and the network node 110 (e.g., the serving network node 110) is valid. The SDT timing alignment timer may be initiated by the UE 120 after the UE 120 receives the RRC release communication. For example, if the SDT timing alignment timer is not expired, then the fifth condition may be satisfied. If the SDT timing alignment timer is expired, then the fifth condition may not be satisfied.

The first one or more conditions associated with selecting resources from the CG-SDT configuration may include a sixth condition associated with whether radio resources (e.g., time domain resources, frequency domain resources, spatial domain resources, and/or code domain resources) associated with selected resource(s) from the CG-SDT configuration at least partially overlap with radio resources of another communication having a higher priority than the uplink communication (e.g., the CG-SDT communication). For example, the sixth condition may be associated with whether any CG-SDT transmissions overlap with or collide (e.g., in the time domain) with other prioritized uplink channel or signal transmissions (e.g., PRACH transmissions, or PUCCH transmission) or downlink channel or signal receptions (e.g., SSB, SI, and/or paging). If the time domain resources associated with selected resource(s) from the CG-SDT configuration do not overlap with time domain resources of another communication having a higher priority than the uplink communication (e.g., the CG-SDT communication), then the sixth condition may be satisfied. If time domain resources associated with selected resource(s) from the CG-SDT configuration at least partially overlap with time domain resources of another communication having a higher priority than the uplink communication (e.g., the CG-SDT communication), then the sixth condition may not be satisfied.

In some aspects, the UE 120 may select uplink resources from the CG-SDT configuration only if the first condition, second condition, third condition, fourth condition, fifth condition, and sixth condition described above are satisfied. In other words, if any one of the conditions described above are not satisfied, then the UE 120 may not select uplink resources from the CG-SDT configuration for the MT-SDT operation. In other aspects, if a quantity of conditions that are satisfied satisfies a threshold, then the UE 120 may select uplink resources from the CG-SDT configuration for the MT-SDT operation. As another example, if a certain combination of conditions are satisfied, then the UE 120 may select uplink resources from the CG-SDT configuration for the MT-SDT operation.

If CG-SDT resources are not configured on the UE 120, or are configured, but not selected by the UE 120 for CG PUSCH transmission (i.e., because the first one or more conditions described above are not satisfied), then the UE 120 may attempt to select RA-SDT resources for performing the MT-SDT operation. For example, if RA-SDT resources are configured on the uplink for a UE 120 in the RRC inactive mode or the RRC idle mode for MO-SDT transmission, then the UE 120 may select the RA-SDT resources for performing the MT-SDT operation if the second one or more conditions are satisfied.

For example, the second one or more conditions associated with selecting resources from the RA-SDT configuration may include a first condition associated with one or more network nodes from which the UE 120 received the indication that the UE is to perform the MT-SDT operation (e.g., the paging signal as described above in connection with reference number 825), the RRC communication that caused the UE 120 to transition to an RRC inactive mode (e.g., the RRC release communication described above in connection with reference number 815), and the RA-SDT configuration being included in a RNA associated with the UE 120. For example, the first condition may be associated with one or more network nodes within a RNA of the UE 120, from which the UE 120 received the indication that the UE 120 is to receive MT-SDT messages, an RRC release message that caused the UE 120 to transition to an RRC inactive mode to perform the MT-SDT procedure, the configurations for MT-SDT and RA-SDT, and the subsequent downlink and uplink communications associated with configured MT-SDT and RA-SDT procedures. In other words, the UE 120 may receive the RRC release communication from an anchor network node, may receive the paging signal from a last serving network node, and may receive the RA-SDT configuration from a serving network node. The anchor network node, the last serving network node, and the serving network node may be the same network node 110 or may be different network nodes 110. The first condition may be associated with whether the anchor network node, the last serving network, and the serving network node all being geographically located within the RNA of the UE 120. For example, if the anchor network node, the last serving network, and the serving network node are all geographically located within the RNA of the UE 120, then the first condition may be satisfied. If at least one of the anchor network node, the last serving network, or the serving network node are not geographically located within the RNA of the UE 120, then the first condition may not be satisfied.

The second one or more conditions associated with selecting resources from the RA-SDT configuration may include a second condition associated with whether a data volume of pending uplink data across all SDT radio bearers satisfies one or more uplink data volume threshold (e.g., DataVolume Threshold-ra-sdt). For example, the second condition may be associated with whether a data volume of pending uplink data across all SDT radio bearers satisfies a set of uplink data volume thresholds configured for MT-SDT, and/or RA-SDT, among other examples. For example, the second condition may be associated with whether data volume of the pending UL data across all SDT radio bearers is no larger than a pre-configured DataVolume Threshold-ra-sdt indicated by a network node 110 (e.g., indicated by the serving network node). If the data volume satisfies the uplink data volume threshold, then the second condition may be satisfied. If the data volume does not satisfy the uplink data volume threshold, then the second condition may not be satisfied.

The second one or more conditions associated with selecting resources from the RA-SDT configuration may include a third condition associated with whether a measurement value of a downlink reference signal (e.g., an SSB or another reference signal) satisfies one or more random access SDT threshold (e.g., RSRPThreshold-ra-sdt). For example, the third condition may be associated with whether a measurement value of a downlink reference signal satisfies a set of thresholds for link quality evaluation associated with MT-SDT and/or RA-SDT, among other examples. For example, the third condition may be associated with whether an RSRP of a downlink pathloss reference signal is greater than or equal to a pre-configured RSRPThreshold-ra-sdt indicated by the serving network node 110. The UE 120 may measure the RSRP of a downlink pathloss reference signal via measurement an SSB, a CSI-RS, a TRS, a PRS, an RSS, a wake-up signal, a low-power wake-up signal, and/or another downlink reference signal transmitted by the serving network node 110. If the RSRP of the downlink reference signal satisfies the random access SDT threshold, then the third condition may be satisfied. If the RSRP of the downlink reference signal does not satisfy the random access SDT threshold, then the third condition may not be satisfied.

The second one or more conditions associated with selecting resources from the RA-SDT configuration may include a fourth condition associated with whether radio resources associated with selected uplink resource(s) from the RA-SDT configuration at least partially overlap with radio resources of another communication having a higher priority than the RA-SDT communications. For example, the fourth condition may be associated with whether radio resources associated with MT-SDT and RA-SDT overlap with radio resources of another communication having a higher priority than the SDT communication. For example, the fourth condition may be associated with whether the RA-SDT transmissions overlap with or collide with (e.g., in the time domain) other prioritized uplink channel or signal transmissions or downlink channel or signal receptions (e.g., SSB, SI, or paging). For example, if the time domain resources associated with selected resource(s) from the RA-SDT configuration do not overlap with time domain resources of another communication having a higher priority than the uplink communication (e.g., the RA-SDT communication), then the fourth condition may be satisfied. If time domain resources associated with selected resource(s) from the RA-SDT configuration at least partially overlap with time domain resources of another communication having a higher priority than the uplink communication (e.g., the RA-SDT communication), then the fourth condition may not be satisfied.

In some aspects, the UE 120 may select uplink resources from the RA-SDT configuration only if the first condition, second condition, third condition, and fourth condition described above are satisfied. In other words, if any one of the conditions described above are not satisfied, then the UE 120 may not select uplink resources from the RA-SDT configuration for the MT-SDT operation. In other aspects, if a quantity of conditions that are satisfied satisfies a threshold, then the UE 120 may select uplink resources from the RA-SDT configuration for the MT-SDT operation. As another example, if a certain combination of conditions are satisfied, then the UE 120 may select uplink resources from the RA-SDT configuration for the MT-SDT operation.

If CG-SDT resources and RA-SDT resources are not available (e.g., not configured, not selected, or invalid) for the UE 120, then the UE 120 may attempt to select uplink resources configured for a RACH procedure (e.g., a four-step RACH procedure or a two-step RACH procedure) may be selected by the UE for performing the MT-SDT procedure. In some aspects, the UE 120 may select uplink resources from a random access configuration (e.g., a non-SDT random access configuration) based at least in part on a third one or more conditions being satisfied.

The third one or more conditions being satisfied associated with selecting resources from the random access configuration may include a first condition associated with one or more network nodes from which the UE 120 received the indication that the UE is to perform the MT-SDT operation (e.g., the paging signal as described above in connection with reference number 825), the RRC communication that caused the UE 120 to transition to an RRC inactive mode (e.g., the RRC release communication described above in connection with reference number 815), and the random access configuration being included in a RNA associated with the UE 120. For example, the first condition may be associated with one or more network nodes within the RNA of the UE 120 from which the UE 120 received the indication that the UE 120 is to receive MT-SDT messages for the MT-SDT operation, an RRC release message that caused the UE 120 to transition to an RRC inactive mode to perform the MT-SDT operation, the configurations for random access and MT-SDT, and subsequent downlink and/or uplink communications associated with configured MT-SDT and RA procedures. In other words, the UE 120 may receive the RRC release communication from an anchor network node, may receive the paging signal from a last serving network node, and may receive the random access configuration from a serving network node. The anchor network node, the last serving network node, and the serving network node may be the same network node 110 or may be different network nodes 110. The first condition may be associated with whether the anchor network node, the last serving network, and the serving network node all being geographically located within the RNA of the UE 120. For example, if the anchor network node, the last serving network, and the serving network node are all geographically located within the RNA of the UE 120, then the first condition may be satisfied. If at least one of the anchor network node, the last serving network, or the serving network node are not geographically located within the RNA of the UE 120, then the first condition may not be satisfied.

The third one or more conditions being satisfied associated with selecting resources from the random access configuration may include a second condition associated with whether a measurement value of a downlink reference signal (e.g., an SSB or another reference signal) satisfies one or more SDT thresholds (e.g., RSRPThreshold-sdt). For example, the second condition may be associated with whether a measurement value of a downlink reference signal satisfies a set of thresholds for link quality evaluation associated with MT-SDT and/or random access procedure(s), among other examples. For example, the second condition may be associated with whether an RSRP of a downlink pathloss reference signal is greater than or equal to a pre-configured RSRPThreshold-sdt indicated by the serving network node 110. The UE 120 may measure the RSRP of a downlink pathloss reference signal via measurement an SSB, a CSI-RS, a TRS, a PRS, an RSS, a wake-up signal, a low-power wake-up signal, and/or another downlink reference signal transmitted by the serving network node 110. If the RSRP of the downlink reference signal satisfies the SDT threshold, then the second condition may be satisfied. If the RSRP of the downlink reference signal does not satisfy the SDT threshold, then the second condition may not be satisfied.

The third one or more conditions being satisfied associated with selecting resources from the random access configuration may include a third condition associated with whether radio resources associated with the uplink resource(s) associated with the random access configuration at least partially overlap with radio resources of another communication having a higher priority than the random access communications. For example, the third condition may be associated with whether the random access transmissions overlap with or collide with (e.g., in the time domain) other prioritized uplink channel or signal transmissions or downlink channel or signal receptions (e.g., SSB, SI, or paging). For example, if the time domain resources associated with selected resource(s) from the random access configuration do not overlap with time domain resources of another communication having a higher priority than the uplink communication (e.g., the random access communication), then the third condition may be satisfied. If time domain resources associated with selected resource(s) from the random access configuration at least partially overlap with time domain resources of another communication having a higher priority than the uplink communication (e.g., the random access communication), then the third condition may not be satisfied.

In some aspects, the UE 120 may select uplink resources from the random access configuration only if the first condition, second condition, and third condition described above are satisfied. In other words, if any one of the conditions described above are not satisfied, then the UE 120 may not select uplink resources from the random access configuration for the MT-SDT operation. In other aspects, if a quantity of conditions that are satisfied satisfies a threshold, then the UE 120 may select uplink resources from the random access configuration for the MT-SDT operation. As another example, if a certain combination of conditions are satisfied, then the UE 120 may select uplink resources from the random access configuration for the MT-SDT operation. If the UE 120 is unable to select resources from the CG-SDT configuration, the RA-SDT configuration, or the random access configuration, then the UE 120 may terminate or abort the MT-SDT operation.

As shown by reference number 835, the UE 120 may transmit (e.g., using communication manager 140, transmission component 1104, controller/processor 280, transmit processor 264, TX MIMO processor 266, MOD 254, antenna 252, and/or memory 282), and the network node 110 may receive, a response (e.g., to the paging signal) using an uplink resource selected by the UE 120 (e.g., as described elsewhere herein in more detail). For example, the response may be an uplink communication. In some aspects, the response may be, or may be included in, an RRC resume request communication. In some aspects, the UE 120 may transmit the response in accordance with the configuration information (e.g., power control information or timing control information, among other examples, as described elsewhere herein). Additionally, or alternatively, the response may include additional information associated with SDT procedures, as described in more detail elsewhere herein. For example, the response may be a CG communication (e.g., if resources from the CG-SDT configuration are selected). As another example, the response may be a RA-SDT communication (e.g., if resources from the RA-SDT configuration are selected). As another example, the response may be a RACH communication (e.g., if resources from the random access configuration are selected).

As shown by reference number 840, the network node 110 may transmit (e.g., using communication manager 150, transmission component 1204, controller/processor 240, transmit processor 220, TX MIMO processor 230, MOD 232, antenna 234, and/or memory 242), and the UE 120 may receive (e.g., using communication manager 140, reception component 1102, antenna 252, DEMOD 254, MIMO detector 256, receive processor 258, controller/processor 280, and/or memory 282), a downlink communication (e.g., a MT-SDT communication). In some aspects, the UE 120 may transition to the RRC idle mode, the RRC inactive mode, or the RRC connected mode based at least in part on the downlink communication. As shown by reference number 845, the UE 120 may transmit, and the network node 110 may receive, an MO-SDT communication (e.g., in response to the MT-SDT communication). In other words, based at least in part on the UE 120 selecting an uplink resource and transmitting the response, an SDT session may be initiated for the MT-SDT operation. After a successfully completion of a MT-SDT session, the UE 120 may be configured or indicated to transition to the RRC idle mode (e.g., via an RRCRelease), the RRC inactive mode (e.g., via an RRCRelease or RRCReject), or the RRC connected mode (e.g., via an RRCResume or RRCSetup).

In some aspects, an MT-SDT session may be terminated by the network (e.g., the network node 110) or the UE 120. For example, early termination of an MT-SDT session can be initiated by the network and/or UE 120. For example, as shown by reference number 850, the UE 120 may detect a termination event. The UE 120 may terminate the session based at least in part detecting the termination event. For example, detecting a termination event may include detecting that an SDT inactivity timer has expired prior to detecting or decoding a downlink control communication associated with the MT-SDT operation. For example, the UE 120 may terminate the session based at least in part on not detecting any PDCCH communication or failing to decode any PDCCH communications before an SDT-specific inactivity timer expires (e.g., where the SDT-specific inactivity timer may be configured by an anchor network node or a serving network node via SI signaling, RRC signaling, and/or MAC-CE signaling).

Additionally, or alternatively, detecting a termination event may include detecting that a measurement value of a downlink signal (e.g., an SSB or another reference signal) does not satisfy an SDT measurement value threshold. For example, the UE 120 may terminate the session based at least in part on an RSRP measurement of a downlink pathloss reference being less than an SDT-specific RSRP threshold (e.g., that is configured by anchor network node or a serving network node via SI signaling, RRC signaling, and/or MAC-CE signaling). Additionally, or alternatively, detecting a termination event may include detecting that an SDT timing alignment timer and/or a HARQ RTT has expired prior to the UE 120 transmitting feedback information for a downlink communication associated with the MT-SDT operation. For example, the UE 120 may terminate the session based at least in part on a timing alignment timer expires before the UE 120 transmits HARQ feedback to a PDSCH of MT-SDT communication(s) or other downlink messages from the serving network node during the session.

Additionally, or alternatively, detecting a termination event may include selecting another network node to be associated with the MT-SDT operation and detecting a failure associated with the other network node obtaining context information associated with the UE. For example, the UE 120 may terminate the session based at least in part on the UE 120 re-selecting another network node, where the other network node cannot fetch UE context information for the UE 120 from the last serving network node. Additionally, or alternatively, detecting a termination event may include detecting that a geographic location of the UE 20 is outside of the RNA associated with the MT-SDT operation. For example, the UE 120 may terminate the session based at least in part on the UE 120 moving out the RNA or if the UE 120 cannot be reached by any network node in the RNA that supported MT-SDT.

Additionally, or alternatively, detecting a termination event may include receiving a system information communication or an emergency notification communication (e.g., an earthquake and tsunami warning system (ETWS) communication or a commercial mobile alert system (CMAS) communication) that at least partially overlaps in a time domain with a downlink communication associated with the session. For example, the UE 120 may terminate the session based at least in part on receiving a paging message for SI modification, an ETWS communication, and/or CMAS communication, among other examples, which collides (e.g., at least partially overlaps in the time domain) with one or multiple PDCCH and/or PDSCH receptions of the session.

Additionally, or alternatively, detecting a termination event may include detecting that an SDT failure detection timer has expired. For example, the UE 120 may terminate the session based at least in part on a SDT failure detection timer expires where an SDT-specific failure detection timer may be configured by an anchor network node or a serving network node via SI signaling, RRC signaling, and/or MAC-CE signaling. Additionally, or alternatively, detecting a termination event may include detecting that a quantity of PRACH preamble transmissions by the UE 120 satisfies a threshold. For example, the UE 120 may terminate the session based at least in part on a MAC entity of the UE 120 detecting that the quantity of PRACH preamble transmissions by the UE 120 satisfies a configured maximum PRACH preamble transmission threshold. Additionally, or alternatively, detecting a termination event may include detecting that a quantity of retransmissions performed by the UE 120 satisfies a threshold. For example, the UE 120 may terminate the session based at least in part on am RLC entity of the UE 120 detecting that the quantity of retransmissions performed by the UE 120 (or the RLC entity) satisfies a configured maximum retransmission threshold.

Additionally, or alternatively, detecting a termination event may include detecting that a response to an uplink communication (e.g., an initial PUSCH communication) has not been received by the UE 120. For example, the UE 120 may terminate the session based at least in part on not receiving a response from the network after an initial PUSCH transmission of the session. For example, the UE 120 may terminate the session based at least in part on not receiving a response to the UE's communication for RRC resume request (e.g., which may be mandatory for MT-SDT), common control channel (CCCH) message (e.g., which may be mandatory for MO-SDT), and/or random access messages carrying an indication of an identity of the UE 120 (e.g., which may be mandatory for contention resolution of RA), among other examples. Additionally, or alternatively, detecting a termination event may include detecting that a power headroom of the UE 120 does not satisfy an SDT power headroom threshold. For example, the UE 120 may terminate the session based at least in part on the power headroom of the UE 120 being less than or equal to an SDT-specific threshold (e.g., that is configured by anchor network node or a serving network node via RRC signaling and/or MAC-CE signaling).

In some aspects, based at least in part on terminating the session early, the UE 120 may transmit, and the network node 110 may receive a communication indicating that the session has been terminated. In some aspects, as shown by reference number 855, the UE 120 may receive, and the network node 110 may transmit, an RRC release communication (e.g., that terminates the session).

As a result, conditions may be defined for the use of various MO-SDT configurations to be used to respond to a paging communication triggering a MT-SDT procedure. This may improve an efficiency of resource utilization because the UE 120 may be enabled to use resources configured for MO-SDT procedures to respond to the paging communication triggering a MT-SDT procedure (e.g., thereby not requiring additional resources to be configured or allocated for the MT-SDT procedure). Additionally, this may reduce a signaling overhead, latency, and/or power consumption that would have otherwise been associated with the MT-SDT procedure due to the configuration and/or use of additional resources (e.g., to be used by the UE 120 to respond to the paging communication). Further, this may improve a mobility and enhance a wireless communication coverage for SDT receptions and/or transmissions by defining the use of various MO-SDT configurations to be used when different network nodes 110 trigger a MT-SDT operation.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., the UE 120) performs operations associated with resource configuration and selection for downlink SDTs.

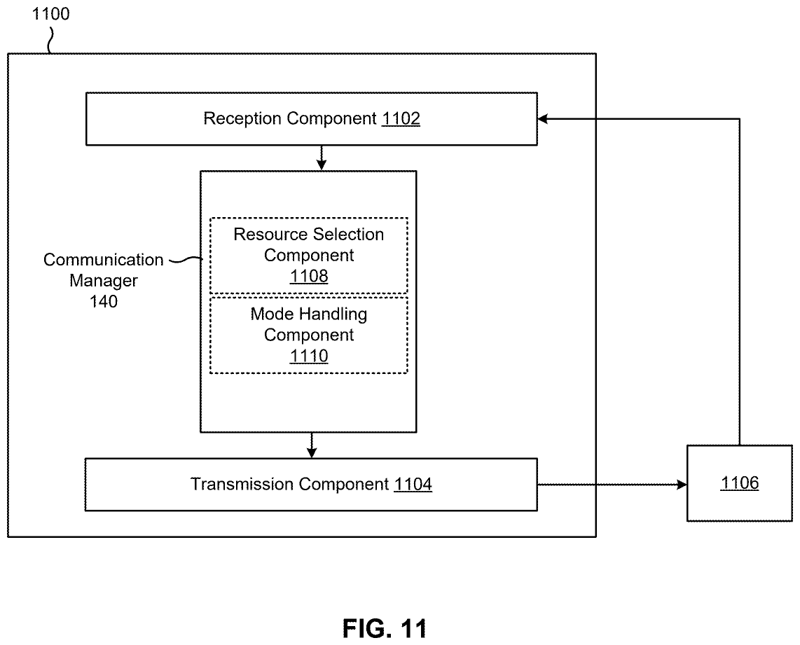

As shown in FIG. 9, in some aspects, process 900 may include receiving, from a network node, an indication that the UE is to perform an MT-SDT operation (block 910). For example, the UE (e.g., using communication manager 140 and/or reception component 1102, depicted in FIG. 11) may receive, from a network node, an indication that the UE is to perform an MT-SDT operation, as described above.

As shown in FIG. 9, in some aspects, process 900 may optionally include selecting a resource from an MO-SDT configuration or a random access configuration to be used for the MT-SDT operation (block 920). For example, the UE (e.g., using communication manager 140 and/or resource selection component 1108, depicted in FIG. 11) may select a resource from an MO-SDT configuration or a random access configuration to be used for the MT-SDT operation. For example, the UE may determine whether a first one or more conditions are satisfied. If the first one or more conditions are satisfied (e.g., Yes), then the UE may select one or more resources from a CG-SDT configuration for the MT-SDT operation. If the first one or more conditions are not satisfied (e.g., No), then the UE may determine whether a second one or more conditions are satisfied. If the second one or more conditions are satisfied (e.g., Yes), then the UE may select one or more resources from an RA-SDT configuration for the MT-SDT operation. If the second one or more conditions are not satisfied (e.g., No), then the UE may select one or more resources from a random access (e.g., RACH) configuration.

As further shown in FIG. 9, in some aspects, process 900 may include transmitting, to the network node, a communication in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE (block 930). For example, the UE (e.g., using communication manager 140 and/or transmission component 1104, depicted in FIG. 11) may transmit, to the network node, a communication in response to the indication using: a first uplink resource associated with an MO-SDT configuration (e.g., the CG-SDT configuration or the RA-SDT configuration) based at least in part on one or more conditions (e.g., the first one or more conditions and/or the second one or more conditions) being satisfied, or a second uplink resource associated with a random access configuration based at least in part on the one or more conditions not being satisfied or based at least in part on no MO-SDT configurations being configured for the UE, as described above.

Process 900 may include additional aspects, such as any single aspect or any combination of aspects described below and/or in connection with one or more other processes described elsewhere herein.

In a first aspect, the UE is operating in an RRC idle mode or an RRC inactive mode. In a second aspect, alone or in combination with the first aspect, the indication that the UE is to perform the MT-SDT operation is included in a paging signal. In a third aspect, alone or in combination with one or more of the first and second aspects, the communication is included in an RRC resume request communication. In a fourth aspect, alone or in combination with one or more of the first through third aspects, the MT-SDT operation is associated with a downlink SDT operation, and wherein the MO-SDT configuration is associated with an uplink SDT configuration.

In a fifth aspect, alone or in combination with one or more of the first through fourth aspects, the MO-SDT configuration includes at least one of a CG-SDT configuration or an RA-SDT configuration.

In a sixth aspect, alone or in combination with one or more of the first through fifth aspects, the MO-SDT configuration includes a CG-SDT configuration or a random access SDT configuration, and wherein the communication is associated with the CG-SDT configuration based at least in part on a first one or more conditions, from the one or more conditions, being satisfied, the RA-SDT configuration based at least in part on the first one or more conditions not being satisfied and based at least in part on a second one or more conditions, from the one or more conditions, being satisfied, or the random access configuration based at least in part on the first one or more conditions and the second one or more conditions not being satisfied.

In a seventh aspect, alone or in combination with one or more of the first through sixth aspects, the first one or more conditions include at least one of a first condition associated with whether the network node is a serving network node from which the UE received an RRC release communication that caused the UE to transition to an RRC inactive mode, a second condition associated with whether the CG-SDT configuration is received from the serving network node, a third condition associated with whether a data volume of pending uplink data across all SDT radio bearers satisfies one or more uplink data volume thresholds, a fourth condition associated with whether a measurement value of a downlink reference signal satisfies one or more uplink CG thresholds, a fifth condition associated with whether an SDT timing alignment timer or a HARQ RTT is expired, or a sixth condition associated with whether radio resources associated with the first uplink resource at least partially overlap with radio resources of another communication having a higher priority than the communication.

In an eighth aspect, alone or in combination with one or more of the first through seventh aspects, the second one or more conditions include at least one of a first condition associated with one or more network nodes, including the network node, from which the UE received the indication that the UE is to perform the MT-SDT operation, an RRC release communication that caused the UE to transition to an RRC inactive mode, and the random access SDT configuration being included in an RNA associated with the UE, a second condition associated with whether a data volume of pending uplink data across all SDT radio bearers satisfies one or more uplink data volume thresholds, a third condition associated with whether a measurement value of a downlink reference signal satisfies one or more random access SDT threshold, or a fourth condition associated with whether radio resources associated with the first uplink resource at least partially overlap with radio resources of another communication having a higher priority than the communication.

In a ninth aspect, alone or in combination with one or more of the first through eighth aspects, the communication being associated with the random access configuration is further based at least in part on a third one or more conditions being satisfied, wherein the third one or more conditions include at least one of a first condition associated with one or more network nodes, including the network node, from which the UE received the indication that the UE is to perform the MT-SDT operation, an RRC release communication that caused the UE to transition to an RRC inactive mode, and the random access configuration being included in an RNA associated with the UE, a second condition associated with whether a measurement value of a downlink reference signal satisfies one or more SDT thresholds, or a third condition associated with whether radio resources associated with the second uplink resource at least partially overlap with radio resources of another communication having a higher priority than the communication.

In a tenth aspect, alone or in combination with one or more of the first through ninth aspects, process 900 includes receiving configuration information associated with the MT-SDT operation.

In an eleventh aspect, alone or in combination with one or more of the first through tenth aspects, the configuration information indicates that PRACH resources associated with the MO-SDT configuration or the random access configuration are to be shared with the MT-SDT operation.

In a twelfth aspect, alone or in combination with one or more of the first through eleventh aspects, the configuration information is associated with at least one of system information signaling, radio resource control signaling, MAC-CE signaling, or downlink control information signaling.

In a thirteenth aspect, alone or in combination with one or more of the first through twelfth aspects, the configuration information includes information associated with one or more timers associated with at least one of the MT-SDT operation, the MO-SDT configuration, or the random access configuration, and wherein the information associated with one or more timers is associated with at least one of radio resource control signaling, MAC control element signaling, or downlink control information signaling.

In a fourteenth aspect, alone or in combination with one or more of the first through thirteenth aspects, the configuration information includes power control information for downlink communications or uplink communications, including the communication, associated with the MT-SDT operation.

In a fifteenth aspect, alone or in combination with one or more of the first through fourteenth aspects, the power control information includes a power control command, and wherein receiving the configuration information includes receiving an indication of the power control command via at least one of MAC control element signaling, or downlink control information signaling.

In a sixteenth aspect, alone or in combination with one or more of the first through fifteenth aspects, the configuration information includes timing control information for downlink communications or uplink communications, including the communication, associated with the MT-SDT operation.

In a seventeenth aspect, alone or in combination with one or more of the first through sixteenth aspects, the timing control information includes at least one of a timing advance command, a configuration for a reference signal associated with tracking loops and measurements, information for timing control associated with multiple serving network nodes of the UE, information associated with reporting timing advance information, or information associated with reporting assistance information for timing control, or mobility management and measurement relaxation.

In an eighteenth aspect, alone or in combination with one or more of the first through seventeenth aspects, the timing control information includes an SFTD between the network node and other or more other network nodes, and wherein receiving the configuration information includes receiving an indication of the SFTD via at least one of unicast signaling, multicast signaling, or broadcast signaling.

In a nineteenth aspect, alone or in combination with one or more of the first through eighteenth aspects, the configuration information includes a pathloss reference signal configuration, and wherein receiving the configuration information includes receiving the pathloss reference signal configuration or a modification to the pathloss reference signal configuration via at least one of radio resource control signaling, MAC-CE signaling, or downlink control information signaling.

In a twentieth aspect, alone or in combination with one or more of the first through nineteenth aspects, process 900 includes transmitting a UAI communication indicating mobility information associated with the UE, wherein the configuration information indicates a reduced RRM measurement configuration based at least in part on transmitting the UAI communication.

In a twenty-first aspect, alone or in combination with one or more of the first through twentieth aspects, the configuration information indicates a reduced downlink control channel monitoring or timeline configuration, and wherein receiving the configuration information includes receiving the reduced downlink control channel monitoring or timeline configuration via at least one of radio resource control signaling, MAC-CE signaling, or downlink control information signaling.

In a twenty-second aspect, alone or in combination with one or more of the first through twenty-first aspects, the configuration information indicates SPS or semi-static resources for a downlink channel associated with the MT-SDT operation based at least in part on second one or more conditions being satisfied.

In a twenty-third aspect, alone or in combination with one or more of the first through twenty-second aspects, the second one or more conditions include at least one of a first condition associated with whether the communication, including an RRC resume message, is successfully transmitted, a second condition associated with whether mobility information and a link status associated with the UE is reported to the network node, a third condition associated with whether the indication for any subsequent downlink communication or uplink communication associated with the MT-SDT operation are received from the network node, a fourth condition associated with whether a measurement value of a downlink reference signal satisfies a threshold for link quality evaluation and timing alignment timer validation configured for SPS or semi-static communications, a fifth condition associated with whether the UE is configured with uplink resources, for providing HARQ feedback associated with the MT-SDT operation, that occur prior to an expiration of a SDT timing alignment timer, a sixth condition associated with whether an SDT error detection timer, that is initiated after an initial transmission or reception of the MT-SDT operation, has expired, or a seventh condition associated with whether the network node is a serving network node for the UE and is included in an RNA associated with the UE.

In a twenty-fourth aspect, alone or in combination with one or more of the first through twenty-third aspects, process 900 includes receiving, from the network node, a downlink communication associated with the MT-SDT operation, and transitioning to at least one of an RRC idle mode, an RRC inactive mode, or an RRC connected mode based at least in part on the downlink communication.

In a twenty-fifth aspect, alone or in combination with one or more of the first through twenty-fourth aspects, the MT-SDT operation is associated with a session, and process 900 includes detecting a termination event, and terminating the session based at least in part detecting the termination event. In a twenty-sixth aspect, alone or in combination with one or more of the first through twenty-fifth aspects, detecting the termination event includes detecting that an SDT inactivity timer has expired prior to detecting or decoding a downlink control communication associated with the MT-SDT operation. In a twenty-seventh aspect, alone or in combination with one or more of the first through twenty-sixth aspects, detecting the termination event includes detecting that a measurement value of a downlink signal does not satisfy an SDT measurement value threshold.

In a twenty-eighth aspect, alone or in combination with one or more of the first through twenty-seventh aspects, detecting the termination event includes detecting that an SDT timing alignment timer has expired prior to transmitting feedback information for a downlink communication associated with the MT-SDT operation. In a twenty-ninth aspect, alone or in combination with one or more of the first through twenty-eighth aspects, detecting the termination event includes selecting another network node to be associated with the MT-SDT operation, and detecting a failure associated with the other network node obtaining context information associated with the UE. In a thirtieth aspect, alone or in combination with one or more of the first through twenty-ninth aspects, detecting the termination event includes detecting that a geographic location of the UE is outside of a RNA associated with the MT-SDT operation.

In a thirty-first aspect, alone or in combination with one or more of the first through thirtieth aspects, detecting the termination event includes receiving a system information communication or an emergency notification communication that at least partially overlaps in a time domain with a downlink communication associated with the session. In a thirty-second aspect, alone or in combination with one or more of the first through thirty-first aspects, detecting the termination event includes detecting that an SDT failure detection timer has expired. In a thirty-third aspect, alone or in combination with one or more of the first through thirty-second aspects, detecting the termination event includes detecting that a quantity of PRACH preamble transmissions by the UE satisfies a threshold.

In a thirty-fourth aspect, alone or in combination with one or more of the first through thirty-third aspects, detecting the termination event includes detecting that a quantity of retransmissions performed by the UE satisfies a threshold. In a thirty-fifth aspect, alone or in combination with one or more of the first through thirty-fourth aspects, detecting the termination event includes detecting that a response to the communication has not been received by the UE. In a thirty-sixth aspect, alone or in combination with one or more of the first through thirty-fifth aspects, detecting the termination event includes detecting that a power headroom of the UE does not satisfy an SDT power headroom threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., the network node 110) performs operations associated with resource configuration and selection for downlink SDTs.

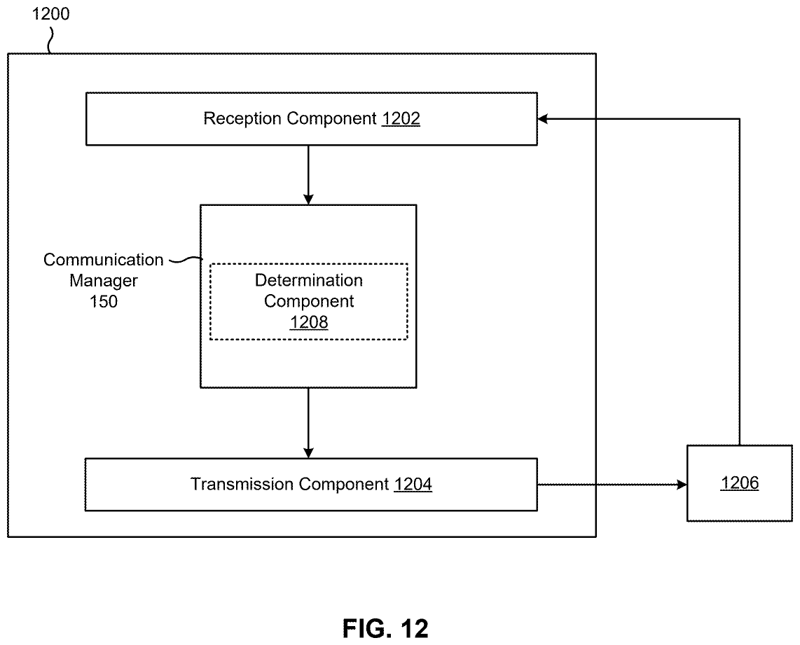

As shown in FIG. 10, in some aspects, process 1000 may include transmitting an indication, intended for a UE, that the UE is to perform an MT-SDT operation (block 1010). For example, the network node (e.g., using communication manager 150 and/or transmission component 1204, depicted in FIG. 12) may transmit an indication, intended for a UE, that the UE is to perform an MT-SDT operation, as described above.

As further shown in FIG. 10, in some aspects, process 1000 may include receiving a communication, associated with the UE, in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE (block 1020). For example, the network node (e.g., using communication manager 150 and/or reception component 1202, depicted in FIG. 12) may receive a communication, associated with the UE, in response to the indication using: a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE, as described above.

Process 1000 may include additional aspects, such as any single aspect or any combination of aspects described below and/or in connection with one or more other processes described elsewhere herein.

In a first aspect, the UE is operating in an RRC idle mode or an RRC inactive mode. In a second aspect, alone or in combination with the first aspect, the indication that the UE is to perform the MT-SDT operation is included in a paging signal. In a third aspect, alone or in combination with one or more of the first and second aspects, the communication is included in an RRC resume request communication. In a fourth aspect, alone or in combination with one or more of the first through third aspects, the MT-SDT operation is associated with an MT SDT operation, and wherein the MO-SDT configuration is associated with an MO SDT configuration. In a fifth aspect, alone or in combination with one or more of the first through fourth aspects, the MO-SDT configuration includes at least one of a CG MO-SDT configuration or a random access SDT configuration.

In a sixth aspect, alone or in combination with one or more of the first through fifth aspects, the MO-SDT configuration includes a CG MO-SDT configuration or a random access SDT configuration, and wherein the communication is associated with the CG MO-SDT configuration based at least in part on a first one or more conditions, from the one or more conditions, being satisfied, the random access SDT configuration based at least in part on the first one or more conditions not being satisfied and based at least in part on a second one or more conditions, from the one or more conditions, being satisfied, or the random access configuration based at least in part on the first one or more conditions and the second one or more conditions not being satisfied.

In a seventh aspect, alone or in combination with one or more of the first through sixth aspects, the first one or more conditions include at least one of a first condition associated with whether the network node is a serving network node that transmitted an RRC communication that caused the UE to transition to an RRC inactive mode, a second condition associated with whether the serving network node transmitted the CG MO-SDT configuration, a third condition associated with whether a data volume of pending uplink data across all SDT radio bearers satisfies an uplink data volume threshold, a fourth condition associated with whether a measurement value of a downlink reference signal satisfies an uplink CG threshold, a fifth condition associated with whether an SDT timing alignment timer is expired, or a sixth condition associated with whether time domain resources associated with the first uplink resource at least partially overlap with time domain resources of another communication having a higher priority than the communication.

In an eighth aspect, alone or in combination with one or more of the first through seventh aspects, the second one or more conditions include at least one of a first condition associated with one or more network nodes, including the network node, that transmitted the indication that the UE is to perform the MT-SDT operation, an RRC communication that caused the UE to transition to an RRC inactive mode, and the random access SDT configuration being included in an RNA associated with the UE, a second condition associated with whether a data volume of pending uplink data across all SDT radio bearers satisfies an uplink data volume threshold, a third condition associated with whether a measurement value of a downlink reference signal satisfies a random access SDT threshold, or a fourth condition associated with whether time domain resources associated with the first uplink resource at least partially overlap with time domain resources of another communication having a higher priority than the communication.

In a ninth aspect, alone or in combination with one or more of the first through eighth aspects, the communication is associated with the random access configuration is further based at least in part on a third one or more conditions being satisfied, wherein the third one or more conditions include at least one of a first condition associated with one or more network nodes, including the network node, that transmitted the indication that the UE is to perform the MT-SDT operation, an RRC communication that caused the UE to transition to an RRC inactive mode, and the random access configuration being included in an RNA associated with the UE, a second condition associated with whether a measurement value of a downlink reference signal satisfies an SDT threshold, or a third condition associated with whether time domain resources associated with the second uplink resource at least partially overlap with time domain resources of another communication having a higher priority than the communication.

In a tenth aspect, alone or in combination with one or more of the first through ninth aspects, process 1000 includes transmitting configuration information, intended for the UE, associated with the MT-SDT operation. In an eleventh aspect, alone or in combination with one or more of the first through tenth aspects, the configuration information indicates that PRACH resources associated with the MO-SDT configuration are to be associated with the MT-SDT operation. In a twelfth aspect, alone or in combination with one or more of the first through eleventh aspects, the configuration information is associated with at least one of system information signaling, radio resource control signaling, MAC-CE signaling, or downlink control information signaling.

In a thirteenth aspect, alone or in combination with one or more of the first through twelfth aspects, the configuration information includes information associated with one or more timers associated with the MT-SDT operation, and wherein the information associated with one or more timers is associated with at least one of radio resource control signaling, MAC-CE signaling, or downlink control information signaling.

In a fourteenth aspect, alone or in combination with one or more of the first through thirteenth aspects, the configuration information includes power control information for uplink communications, including the communication, associated with the MT-SDT operation. In a fifteenth aspect, alone or in combination with one or more of the first through fourteenth aspects, the power control information includes a power control command, and wherein transmitting the configuration information includes transmitting an indication of the power control command via at least one of MAC-CE signaling, or downlink control information signaling.

In a sixteenth aspect, alone or in combination with one or more of the first through fifteenth aspects, the configuration information includes timing control information for uplink communications, including the communication, associated with the MT-SDT operation. In a seventeenth aspect, alone or in combination with one or more of the first through sixteenth aspects, the timing control information includes a timing advance command, and wherein transmitting the configuration information includes transmitting an indication of the timing advance command via at least one of MAC-CE signaling, or downlink control information signaling. In an eighteenth aspect, alone or in combination with one or more of the first through seventeenth aspects, the timing control information includes an SFTD between the network node and other or more other network nodes, and wherein transmitting the configuration information includes transmitting an indication of the SFTD via at least one of unicast signaling, multicast signaling, or broadcast signaling.

In a nineteenth aspect, alone or in combination with one or more of the first through eighteenth aspects, the configuration information includes a pathloss reference signal configuration, and wherein transmitting the configuration information includes transmitting the pathloss reference signal configuration or a modification to the pathloss reference signal configuration via at least one of radio resource control signaling, MAC-CE signaling, or downlink control information signaling.

In a twentieth aspect, alone or in combination with one or more of the first through nineteenth aspects, process 1000 includes receiving a UAI communication indicating mobility information associated with the UE, wherein the configuration information indicates a reduced RRM measurement configuration based at least in part on transmitting the UAI communication.

In a twenty-first aspect, alone or in combination with one or more of the first through twentieth aspects, the configuration information indicates a reduced downlink control channel monitoring or timeline configuration, and wherein transmitting the configuration information includes transmitting the reduced downlink control channel monitoring or timeline configuration via at least one of radio resource control signaling, MAC-CE signaling, or downlink control information signaling.

In a twenty-second aspect, alone or in combination with one or more of the first through twenty-first aspects, the configuration information indicates SPS or semi-static resources for a downlink channel associated with the MT-SDT operation based at least in part on second one or more conditions being satisfied.

In a twenty-third aspect, alone or in combination with one or more of the first through twenty-second aspects, the second one or more conditions include at least one of a first condition associated with whether the communication is successfully received by the network node, a second condition associated with whether mobility information and a link status associated with the UE is received by the network node, a third condition associated with whether the indication and any subsequent downlink communication associated with the MT-SDT operation are transmitted by the network node, a fourth condition associated with whether a measurement value of a downlink reference signal satisfies an SPS threshold, a fifth condition associated with whether the UE is configured with uplink resources, for providing HARQ feedback associated with the MT-SDT operation, that occur prior to an expiration of a SDT timing alignment timer, or a sixth condition associated with whether an SDT timer, that is initiated after an initial transmission of the MT-SDT operation, has expired.

In a twenty-fourth aspect, alone or in combination with one or more of the first through twenty-third aspects, process 1000 includes transmitting a downlink communication associated with the MT-SDT operation.

In a twenty-fifth aspect, alone or in combination with one or more of the first through twenty-fourth aspects, the MT-SDT operation is associated with a session, and process 1000 includes detecting a termination event, and terminating the session based at least in part detecting the termination event.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a resource selection component 1108 and/or a mode handling component 1110, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network node, an indication that the UE is to perform an MT-SDT operation. The transmission component 1104 may transmit, to the network node, a communication in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

The resource selection component 1108 may select the first uplink resource or the second uplink resource based at least in part on determining whether the one or more conditions are satisfied.

The reception component 1102 may receive configuration information associated with the MT-SDT operation. The transmission component 1104 may transmit a UAI communication indicating mobility information associated with the UE wherein the configuration information indicates a reduced RRM measurement configuration based at least in part on transmitting the UAI communication. The reception component 1102 may receive, from the network node, a downlink communication associated with the MT-SDT operation. The mode handling component 1110 may transition to at least one of an RRC idle mode, an RRC inactive mode, or an RRC connected mode based at least in part on the downlink communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a determination component 1208, among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The transmission component 1204 may transmit an indication, intended for a UE, that the UE is to perform an MT-SDT operation. The reception component 1202 may receive a communication, associated with the UE, in response to the indication using a first uplink resource associated with an MO-SDT configuration based at least in part on one or more conditions being satisfied, or a second uplink resource associated with a random access configuration based at least in part on the one or more conditions not being satisfied or based at least in part on no MO-SDT configurations being configured for the UE.

The determination component 1208 may determine the one or more conditions. The determination component 1208 may determine the MO-SDT configuration and/or the random access configuration.

The transmission component 1204 may transmit configuration information, intended for the UE, associated with the MT-SDT operation.

The reception component 1202 may receive a UAI communication indicating mobility information associated with the UE wherein the configuration information indicates a reduced RRM measurement configuration based at least in part on transmitting the UAI communication.

The transmission component 1204 may transmit a downlink communication associated with the MT-SDT operation.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, an indication that the UE is to perform a mobile-terminated (MT) small data transmission (SDT) (MT-SDT) operation; and transmitting, to the network node, a communication in response to the indication using: a first uplink resource associated with an mobile-originated (MO) SDT (MO-SDT) configuration based at least in part on one or more conditions being satisfied, or a second uplink resource associated with a random access configuration based at least in part on the one or more conditions not being satisfied or based at least in part on no MO-SDT configurations being configured for the UE.

Aspect 2: The method of Aspect 1, wherein the UE is operating in a radio resource control (RRC) idle mode or an RRC inactive mode.

Aspect 3: The method of any of Aspects 1-2, wherein the indication that the UE is to perform the MT-SDT operation is included in a paging signal.

Aspect 4: The method of any of Aspects 1-3, wherein the communication is included in a radio resource control (RRC) resume request communication.

Aspect 5: The method of any of Aspects 1-4, wherein the MT-SDT operation is associated with a downlink SDT operation, and wherein the MO-SDT configuration is associated with an uplink SDT configuration.

Aspect 6: The method of any of Aspects 1-5, wherein the MO-SDT configuration includes at least one of a configured grant (CG) SDT (CG-SDT) configuration or a random access SDT (RA-SDT) configuration.

Aspect 7: The method of any of Aspects 1-6, wherein the MO-SDT configuration includes a configured grant (CG) SDT (CG-SDT) configuration or a random access SDT (RA-SDT) configuration, and wherein the communication is associated with: the CG-SDT uplink SDT configuration based at least in part on a first one or more conditions, from the one or more conditions, being satisfied; the random access SDT configuration based at least in part on the first one or more conditions not being satisfied and based at least in part on a second one or more conditions, from the one or more conditions, being satisfied; or the random access configuration based at least in part on the first one or more conditions and the second one or more conditions not being satisfied.

Aspect 8: The method of Aspect 7, wherein the first one or more conditions include at least one of: a first condition associated with whether the network node is a serving network node from which the UE received a radio resource control (RRC) release message that caused the UE to transition to an RRC inactive mode, a second condition associated with whether the CG-SDT configuration is received from the serving network node, a third condition associated with whether a data volume of pending uplink data across all SDT radio bearers satisfies one or more uplink data volume thresholds associated with at least one of the MO-SDT configuration or the MT-SDT operation, a fourth condition associated with whether a measurement value of a downlink reference signal satisfies one or more thresholds for link quality evaluation associated with at least one of the MO-SDT configuration or the MT-SDT operation, a fifth condition associated with whether at least one of an SDT timing alignment timer or a hybrid automatic repeat request (HARQ) round-trip time (RTT) timer is expired, or a sixth condition associated with whether radio resources associated with the first uplink resource at least partially overlap with radio resources of another communication having a higher priority than the communication.

Aspect 9: The method of any of Aspects 7-8, wherein the second one or more conditions include at least one of: a associated with one or more network nodes, including the network node, from which the UE received the indication that the UE is to perform the MT-SDT operation, a radio resource control (RRC) release message that caused the UE to transition to an RRC inactive mode, and configurations for the MT-SDT operation or the RA-SDT configuration, being included in a radio access network (RAN) notification area (RNA) associated with the UE, a second condition associated with whether a data volume of pending uplink data across all SDT radio bearers satisfies one or more uplink data volume threshold associated with at least one of the MO-SDT configuration or the MT-SDT operation, a third condition associated with whether a measurement value of a downlink reference signal satisfies one or more thresholds for link quality evaluation associated at least one of the MO-SDT configuration or the MT-SDT operation, or a fourth condition associated with whether radio resources associated with the first uplink resource at least partially overlap with radio resources of another communication having a higher priority than the communication.

Aspect 10: The method of any of Aspects 7-9, wherein the communication being associated with the random access configuration is further based at least in part on a third one or more conditions being satisfied, wherein the third one or more conditions include at least one of: a first condition associated with one or more network nodes, including the network node, from which the UE received the indication that the UE is to perform the MT-SDT operation, a radio resource control (RRC) release message that caused the UE to transition to an RRC inactive mode, configurations for the MT-SDT operation or the RA-SDT configuration, being included in a radio access network (RAN) notification area (RNA) associated with the UE, a second condition associated with whether a measurement value of a downlink reference signal satisfies one or more thresholds for link quality evaluation associated with at least one of the MT-SDT operation or the random access configuration, or a third condition associated with whether radio resources associated with the second uplink resource at least partially overlap with radio resources of another communication having a higher priority than the communication.

Aspect 11: The method of any of Aspects 1-10, further comprising: receiving configuration information associated with the MT-SDT operation.

Aspect 12: The method of Aspect 11, wherein the configuration information indicates that physical random access channel (PRACH) resources associated with the MO-SDT configuration or the random access configuration are to be shared with the MT-SDT operation.

Aspect 13: The method of any of Aspects 11-12, wherein the configuration information is associated with at least one of system information signaling, radio resource control signaling, medium access control (MAC) control element signaling, or downlink control information signaling.

Aspect 14: The method of any of Aspects 11-13, wherein the configuration information includes information associated with one or more timers associated with the MT-SDT operation, and wherein the information associated with one or more timers is associated with at least one of radio resource control signaling, medium access control (MAC) control element signaling, or downlink control information signaling.

Aspect 15: The method of any of Aspects 11-14, wherein the configuration information includes power control information for uplink communications, including the communication, associated with the MT-SDT operation.

Aspect 16: The method of Aspect 15, wherein the power control information includes a power control command, and wherein receiving the configuration information comprises: receiving an indication of the power control command via at least one of medium access control (MAC) control element signaling, or downlink control information signaling.

Aspect 17: The method of any of Aspects 11-16, wherein the configuration information includes timing control information for downlink communications or uplink communications, including the communication, associated with the MT-SDT operation.

Aspect 18: The method of Aspect 17, wherein the timing control information includes at least one of: a timing advance command, a configuration for a reference signal associated with tracking loops and measurements, information for timing control associated with multiple serving network nodes of the UE, information associated with reporting timing advance information, or information associated with reporting assistance information for timing control, or mobility management and measurement relaxation.

Aspect 19: The method of any of Aspects 17-18, wherein the timing control information includes a system frame timing difference (SFTD) between the network node and other or more other network nodes, and wherein receiving the configuration information comprises: receiving an indication of the SFTD via at least one of unicast signaling, multicast signaling, or broadcast signaling.

Aspect 20: The method of any of Aspects 11-19, wherein the configuration information includes a pathloss reference signal configuration, and wherein receiving the configuration information comprises: receiving the pathloss reference signal configuration or a modification to the pathloss reference signal configuration via at least one of radio resource control signaling, medium access control (MAC) control element signaling, or downlink control information signaling.

Aspect 21: The method of any of Aspects 11-20, further comprising: transmitting a UE assistance information (UAI) communication indicating mobility information associated with the UE, wherein the configuration information indicates a reduced radio resource management (RRM) measurement configuration based at least in part on transmitting the UAI communication.

Aspect 22: The method of any of Aspects 11-21, wherein the configuration information indicates a reduced downlink control channel monitoring or timeline configuration, and wherein receiving the configuration information comprises: receiving the reduced downlink control channel monitoring or timeline configuration via at least one of radio resource control signaling, medium access control (MAC) control element signaling, or downlink control information signaling.

Aspect 23: The method of any of Aspects 11-22, wherein the configuration information indicates semi-persistent scheduling (SPS) or semi-static resources for a downlink channel associated with the MT-SDT operation based at least in part on second one or more conditions being satisfied.

Aspect 24: The method of Aspect 23, wherein the second one or more conditions include at least one of: a first condition associated with whether the communication, including a radio resource control (RRC) resume message, being successfully transmitted, a second condition associated with whether mobility information and a link quality status associated with the UE is reported to the network node, a third condition associated with whether the indication for any subsequent downlink or uplink communication associated with the MT-SDT operation are received from the network node, a fourth condition associated with whether a measurement value of a downlink reference signal satisfies a threshold for link quality evaluation and timing alignment timer validation configured for SPS or semi-static communications, a fifth condition associated with whether the UE is configured with valid uplink resources, for providing hybrid automatic repeat request (HARQ) feedback associated with the MT-SDT operation, that occur prior to an expiration of a SDT timing alignment timer, a sixth condition associated with whether an SDT error detection timer, that is initiated after an initial transmission or reception of the MT-SDT operation, has expired, or a seventh condition associated with whether the network node is a serving network node for the UE and is included in a radio access network (RAN) notification area (RNA) associated with the UE.

Aspect 25: The method of any of Aspects 1-24, further comprising: receiving, from the network node, a downlink communication associated with the MT-SDT operation; and transitioning to at least one of a radio resource control (RRC) idle mode, an RRC inactive mode, or an RRC connected mode based at least in part on the downlink communication.

Aspect 26: The method of any of Aspects 1-25, wherein the MT-SDT operation is associated with a session, the method further comprising: detecting a termination event; and terminating the session based at least in part detecting the termination event.

Aspect 27: The method of Aspect 26, wherein detecting the termination event comprises: detecting that an SDT inactivity timer has expired prior to detecting or decoding a downlink control communication associated with the MT-SDT operation.

Aspect 28: The method of any of Aspects 26-27, wherein detecting the termination event comprises: detecting that a measurement value of a downlink signal does not satisfy one or more SDT measurement value thresholds.

Aspect 29: The method of any of Aspects 26-28, wherein detecting the termination event comprises: detecting that an SDT timing alignment timer has expired prior to transmitting feedback information for a downlink communication associated with the MT-SDT operation.

Aspect 30: The method of any of Aspects 26-29, wherein detecting the termination event comprises: selecting another network node to be associated with the MT-SDT operation; and detecting a failure associated with the other network node obtaining context information associated with the UE.

Aspect 31: The method of any of Aspects 26-30, wherein detecting the termination event comprises: detecting that a geographic location of the UE is outside of a radio access network (RAN) notification area (RNA) associated with the MT-SDT operation.

Aspect 32: The method of any of Aspects 26-31, wherein detecting the termination event comprises: receiving a system information communication or an emergency notification communication that at least partially overlaps in a time domain with a downlink communication associated with the session.

Aspect 33: The method of any of Aspects 26-32, wherein detecting the termination event comprises: detecting that an SDT failure detection timer has expired.

Aspect 34: The method of any of Aspects 26-33, wherein detecting the termination event comprises: detecting that a quantity of physical random access channel (PRACH) preamble transmissions by the UE satisfies a threshold.

Aspect 35: The method of any of Aspects 26-34, wherein detecting the termination event comprises: detecting that a quantity of retransmissions performed by the UE satisfies a threshold.

Aspect 36: The method of any of Aspects 26-35, wherein detecting the termination event comprises: detecting that a response to the communication has not been received by the UE.

Aspect 37: The method of any of Aspects 26-36, wherein detecting the termination event comprises: detecting that a power headroom of the UE does not satisfy an SDT power headroom threshold.

Aspect 38: A method of wireless communication performed by a network node, comprising: transmitting an indication, intended for a user equipment (UE), that the UE is to perform a mobile-terminated (MT) small data transmission (SDT) (MT-SDT) operation; and receiving a communication, associated with the UE, in response to the indication using: a first uplink resource associated with a mobile-originated (MO) SDT (MO-SDT) configuration based at least in part on one or more conditions being satisfied, or a second uplink resource associated with a random access configuration based at least in part on the one or more conditions not being satisfied or based at least in part on no MO-SDT configurations being configured for the UE.

Aspect 39: The method of Aspect 38, wherein the UE is operating in a radio resource control (RRC) idle mode or an RRC inactive mode.

Aspect 40: The method of any of Aspects 38-39, wherein the indication that the UE is to perform the MT-SDT operation is included in a paging signal.

Aspect 41: The method of any of Aspects 38-40, wherein the communication is included in a radio resource control (RRC) resume request communication.

Aspect 42: The method of any of Aspects 38-41, wherein the MT-SDT operation is associated with a downlink SDT operation, and wherein the MO-SDT configuration is associated with an uplink SDT configuration.

Aspect 43: The method of any of Aspects 38-42, wherein the MO-SDT configuration includes at least one of a configured grant (CG) SDT (CG-SDT) configuration or a random access SDT (RA-SDT) configuration.

Aspect 44: The method of any of Aspects 38-43, wherein the MO-SDT configuration includes a configured grant (CG) SDT (CG-SDT) configuration or a random access SDT (RA-SDT) configuration, and wherein the communication is associated with: the CG-SDT configuration based at least in part on a first one or more conditions, from the one or more conditions, being satisfied; the RA-SDT configuration based at least in part on the first one or more conditions not being satisfied and based at least in part on a second one or more conditions, from the one or more conditions, being satisfied; or the random access configuration based at least in part on the first one or more conditions and the second one or more conditions not being satisfied.

Aspect 45: The method of Aspect 44, wherein the first one or more conditions include at least one of: a first condition associated with whether the network node is a serving network node from which the UE received a radio resource control (RRC) release message that caused the UE to transition to an RRC inactive mode, a second condition associated with whether the CG-SDT configuration is received from the serving network node, a third condition associated with whether a data volume of pending uplink data across all SDT radio bearers satisfies one or more uplink data volume thresholds associated with at least one of the MO-SDT configuration or the MT-SDT operation, a condition associated with whether a measurement value of a downlink reference signal satisfies one or more thresholds for link quality evaluation associated with at least one of the MO-SDT configuration or the MT-SDT operation, a fifth condition associated with whether at least one of an SDT timing alignment timer or a hybrid automatic repeat request (HARQ) round-trip time (RTT) timer is expired, or a condition associated with whether radio resources associated with the first uplink resource at least partially overlap with radio resources of another communication having a higher priority than the communication.

Aspect 46: The method of any of Aspects 44-45, wherein the second one or more conditions include at least one of: a first condition associated with one or more network nodes, including the network node, from which the UE received the indication that the UE is to perform the MT-SDT operation, a radio resource control (RRC) release message that caused the UE to transition to an RRC inactive mode, and configurations for the MT-SDT operation or the RA-SDT configuration, being included in a radio access network (RAN) notification area (RNA) associated with the UE, a second condition associated with whether a data volume of pending uplink data across all SDT radio bearers satisfies one or more uplink data volume threshold associated with at least one of the MO-SDT configuration or the MT-SDT operation, a third condition associated with whether a measurement value of a downlink reference signal satisfies one or more thresholds for link quality evaluation associated at least one of the MO-SDT configuration or the MT-SDT operation, or a fourth condition associated with whether radio resources associated with the first uplink resource at least partially overlap with radio resources of another communication having a higher priority than the communication.

Aspect 47: The method of any of Aspects 44-46, wherein the communication being associated with the random access configuration is further based at least in part on a third one or more conditions being satisfied, wherein the third one or more conditions include at least one of: a first condition associated with one or more network nodes, including the network node, from which the UE received the indication that the UE is to perform the MT-SDT operation, a radio resource control (RRC) release message that caused the UE to transition to an RRC inactive mode, configurations for the MT-SDT operation or the RA-SDT configuration, being included in a radio access network (RAN) notification area (RNA) associated with the UE, a second condition associated with whether a measurement value of a downlink reference signal satisfies one or more thresholds for link quality evaluation associated with at least one of the MT-SDT operation or the random access configuration, or a condition associated with whether radio resources associated with the second uplink resource at least partially overlap with radio resources of another communication having a higher priority than the communication.

Aspect 48: The method of any of Aspects 38-47, further comprising: transmitting configuration information, intended for the UE, associated with the MT-SDT operation.

Aspect 49: The method of Aspect 48, wherein the configuration information indicates that physical random access channel (PRACH) resources associated with the MO-SDT configuration or the random access configuration are to be shared with the MT-SDT operation.

Aspect 50: The method of any of Aspects 48-49, wherein the configuration information is associated with at least one of system information signaling, radio resource control signaling, medium access control (MAC) control element signaling, or downlink control information signaling.

Aspect 51: The method of any of Aspects 48-50, wherein the configuration information includes information associated with one or more timers associated with the at least one of the MT-SDT operation, the MO-SDT configuration, or the random access configuration, and wherein the information associated with one or more timers is associated with at least one of radio resource control signaling, medium access control (MAC) control element signaling, or downlink control information signaling.

Aspect 52: The method of any of Aspects 48-51, wherein the configuration information includes power control information for downlink communications or uplink communications, including the communication, associated with the MT-SDT operation.

Aspect 53: The method of Aspect 52, wherein the power control information includes a power control command, and wherein transmitting the configuration information comprises: transmitting an indication of the power control command via at least one of medium access control (MAC) control element signaling, or downlink control information signaling.

Aspect 54: The method of any of Aspects 48-53, wherein the configuration information includes timing control information for downlink communications or uplink communications, including the communication, associated with the MT-SDT operation.

Aspect 55: The method of Aspect 54, wherein the timing control information includes a timing advance command, and wherein transmitting the configuration information comprises: transmitting an indication of the timing advance command via at least one of medium access control (MAC) control element signaling, or downlink control information signaling.

Aspect 56: The method of any of Aspects 54-55, wherein the timing control information includes a system frame timing difference (SFTD) between the network node and other or more other network nodes, and wherein transmitting the configuration information comprises: transmitting an indication of the SFTD via at least one of unicast signaling, multicast signaling, or broadcast signaling.

Aspect 57: The method of any of Aspects 48-56, wherein the configuration information includes a pathloss reference signal configuration, and wherein transmitting the configuration information comprises: transmitting the pathloss reference signal configuration or a modification to the pathloss reference signal configuration via at least one of radio resource control signaling, medium access control (MAC) control element signaling, or downlink control information signaling.

Aspect 58: The method of any of Aspects 48-57, further comprising: receiving a UE assistance information (UAI) communication indicating mobility information associated with the UE, wherein the configuration information indicates a reduced radio resource management (RRM) measurement configuration based at least in part on transmitting the UAI communication.

Aspect 59: The method of any of Aspects 48-58, wherein the configuration information indicates a reduced downlink control channel monitoring or timeline configuration, and wherein transmitting the configuration information comprises: transmitting the reduced downlink control channel monitoring or timeline configuration via at least one of radio resource control signaling, medium access control (MAC) control element signaling, or downlink control information signaling.

Aspect 60: The method of any of Aspects 48-59, wherein the configuration information indicates semi-persistent scheduling (SPS) or semi-static resources for a downlink channel associated with the MT-SDT operation based at least in part on second one or more conditions being satisfied.

Aspect 61: The method of Aspect 60, wherein the second one or more conditions include at least one of: a first condition associated with whether the communication being successfully received by the network node, a second condition associated with whether mobility information and a link status associated with the UE is received by the network node, a third condition associated with whether the indication and any subsequent downlink communication associated with the MT-SDT operation are transmitted by the network node, a fourth condition associated with whether a measurement value of a downlink reference signal satisfies an SPS threshold, a fifth condition associated with whether the UE is configured with uplink resources, for providing hybrid automatic repeat request (HARQ) feedback associated with the MT-SDT operation, that occur prior to an expiration of a SDT timing alignment timer, or a sixth condition associated with whether an SDT timer, that is initiated after an initial transmission of the MT-SDT operation, has expired.

Aspect 62: The method of any of Aspects 38-61, further comprising: transmitting a downlink communication associated with the MT-SDT operation.

Aspect 63: The method of any of Aspects 38-62, wherein the MT-SDT operation is associated with a session, the method further comprising: detecting a termination event; and terminating the session based at least in part detecting the termination event.

Aspect 64: An apparatus for wireless communication at a device, comprising a processor; memory coupled with the processor; and instructions stored in the memory and executable by the processor to cause the apparatus to perform the method of one or more of Aspects 1-37.

Aspect 65: A device for wireless communication, comprising a memory and one or more processors coupled to the memory, the one or more processors configured to perform the method of one or more of Aspects 1-37.

Aspect 66: An apparatus for wireless communication, comprising at least one means for performing the method of one or more of Aspects 1-37.

Aspect 67: A non-transitory computer-readable medium storing code for wireless communication, the code comprising instructions executable by a processor to perform the method of one or more of Aspects 1-37.

Aspect 68: A non-transitory computer-readable medium storing a set of instructions for wireless communication, the set of instructions comprising one or more instructions that, when executed by one or more processors of a device, cause the device to perform the method of one or more of Aspects 1-37.

Aspect 69: An apparatus for wireless communication at a device, comprising a processor; memory coupled with the processor; and instructions stored in the memory and executable by the processor to cause the apparatus to perform the method of one or more of Aspects 38-63.

Aspect 70: A device for wireless communication, comprising a memory and one or more processors coupled to the memory, the one or more processors configured to perform the method of one or more of Aspects 38-63.

Aspect 71: An apparatus for wireless communication, comprising at least one means for performing the method of one or more of Aspects 38-63.

Aspect 72: A non-transitory computer-readable medium storing code for wireless communication, the code comprising instructions executable by a processor to perform the method of one or more of Aspects 38-63.

Aspect 73: A non-transitory computer-readable medium storing a set of instructions for wireless communication, the set of instructions comprising one or more instructions that, when executed by one or more processors of a device, cause the device to perform the method of one or more of Aspects 38-63.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving, from a network node, an indication that the UE is to perform a mobile-terminated (MT) small data transmission (SDT) (MT-SDT) operation; and
transmitting, to the network node, a communication in response to the indication using:
a first uplink resource associated with an mobile-originated (MO) SDT (MO-SDT) configuration based at least in part on one or more conditions being satisfied, or
a second uplink resource associated with a random access configuration based at least in part on the one or more conditions not being satisfied or based at least in part on no MO-SDT configurations being configured for the UE.

2. The method of claim 1, wherein the MO-SDT configuration includes a configured grant (CG) SDT (CG-SDT) configuration or a random access SDT configuration (RA-SDT), and wherein the communication is associated with:
the CG-SDT configuration based at least in part on a first one or more conditions, from the one or more conditions, being satisfied;
the RA-SDT configuration based at least in part on the first one or more conditions not being satisfied and based at least in part on a second one or more conditions, from the one or more conditions, being satisfied; or
the random access configuration based at least in part on the first one or more conditions and the second one or more conditions not being satisfied.

3. The method of claim 2, wherein the first one or more conditions include at least one of:
a first condition associated with whether the network node is a serving network node from which the UE received a radio resource control (RRC) release message that caused the UE to transition to an RRC inactive mode,
a second condition associated with whether the CG-SDT configuration is received from the serving network node,
a third condition associated with whether a data volume of pending uplink data across all SDT radio bearers satisfies one or more uplink data volume thresholds associated with at least one of the MO-SDT configuration or the MT-SDT operation,
a fourth condition associated with whether a measurement value of a downlink reference signal satisfies one or more thresholds for link quality evaluation associated with at least one of the MO-SDT configuration or the MT-SDT operation,
a fifth condition associated with whether at least one of an SDT timing alignment timer or a hybrid automatic repeat request (HARQ) round-trip time (RTT) timer is expired, or
a sixth condition associated with whether radio resources associated with the first uplink resource at least partially overlap with radio resources of another communication having a higher priority than the communication.

4. The method of claim 2, wherein the second one or more conditions include at least one of:
a first condition associated with one or more network nodes, including the network node, from which the UE received the indication that the UE is to perform the MT-SDT operation, a radio resource control (RRC) release message that caused the UE to transition to an RRC inactive mode, and configurations for the MT-SDT operation or the RA-SDT configuration, Being included in a radio access network (RAN) notification area (RNA) associated with the UE,
a second condition associated with whether a data volume of pending uplink data across all SDT radio bearers satisfies one or more uplink data volume threshold associated with at least one of the MO-SDT configuration or the MT-SDT operation,
a third condition associated with whether a measurement value of a downlink reference signal satisfies one or more thresholds for link quality evaluation associated at least one of the MO-SDT configuration or the MT-SDT operation, or
a fourth condition associated with whether radio resources associated with the first uplink resource at least partially overlap with radio resources of another communication having a higher priority than the communication.

5. The method of claim 2, wherein the communication being associated with the random access configuration is further based at least in part on a third one or more conditions being satisfied, wherein the third one or more conditions include at least one of:
a first condition associated with one or more network nodes, including the network node, from which the UE received the indication that the UE is to perform the MT-SDT operation, a radio resource control (RRC) release message that caused the UE to transition to an RRC inactive mode, configurations for the MT-SDT operation or the RA-SDT configuration, being included in a radio access network (RAN) notification area (RNA) associated with the UE,
a second condition associated with whether a measurement value of a downlink reference signal satisfies one or more thresholds for link quality evaluation associated with at least one of the MT-SDT operation or the random access configuration, or
a third condition associated with whether radio resources associated with the second uplink resource at least partially overlap with radio resources of another communication having a higher priority than the communication.

6. The method of claim 1, further comprising:
receiving configuration information associated with the MT-SDT operation via at least one of system information signaling, radio resource control signaling, medium access control (MAC) control element signaling, or downlink control information signaling.

7. The method of claim 6, wherein the configuration information indicates that physical random access channel (PRACH) resources associated with the MO-SDT configuration or the random access configuration are to be shared with the MT-SDT operation.

8. The method of claim 6, wherein the configuration information includes information associated with one or more timers associated with the at least one of the MT-SDT operation, the MO-SDT configuration, or the random access configuration, and
wherein the information associated with one or more timers is associated with at least one of the radio resource control signaling, the MAC control element signaling, or the downlink control information signaling.

9. The method of claim 6, wherein the configuration information includes power control information for downlink communications or uplink communications, including the communication, associated with the MT-SDT operation.

10. The method of claim 6, wherein the configuration information includes timing control information for downlink communications or uplink communications, including the communication, associated with the MT-SDT operation.

11. The method of claim 10, wherein the timing control information includes at least one of:
a timing advance command,
a configuration for a reference signal associated with tracking loops and measurements;
information for timing control associated with multiple serving network nodes of the UE;
information associated with reporting timing advance information; or
information associated with reporting assistance information for timing control, or mobility management and measurement relaxation.

12. The method of claim 10, wherein the timing control information includes a system frame timing difference (SFTD) between the network node and other or more other network nodes, and wherein receiving the configuration information comprises:
receiving an indication of the SFTD via at least one of unicast signaling, multicast signaling, or broadcast signaling.

13. The method of claim 1, wherein the MT-SDT operation is associated with a session, the method further comprising:
detecting a termination event; and
terminating the session based at least in part detecting the termination event.

14. The method of claim 13, wherein detecting the termination event includes detecting that at least one of:
an SDT inactivity timer has expired prior to detecting or decoding a downlink control communication associated with the MT-SDT operation,
a measurement value of a downlink signal does not satisfy an SDT measurement value threshold,
an SDT timing alignment timer has expired prior to transmitting feedback information for a downlink communication associated with the MT-SDT operation,
a geographic location of the UE is outside of a radio access network (RAN) notification area (RNA) associated with the MT-SDT operation,
a system information communication or an emergency notification communication that at least partially overlaps in a time domain with a downlink communication associated with the session,
an SDT failure detection timer has expired,
a quantity of physical random access channel (PRACH) preamble transmissions by the UE satisfies a threshold,
a quantity of retransmissions performed by the UE satisfies a threshold,
a response to the communication has not been received by the UE, or
a power headroom of the UE does not satisfy an SDT power headroom threshold.

15. A method of wireless communication performed by a network node, comprising:
transmitting an indication, intended for a user equipment (UE), that the UE is to perform a mobile-terminated (MT) small data transmission (SDT) (MT-SDT) operation; and
receiving a communication, associated with the UE, in response to the indication using:
a first uplink resource associated with a mobile-originated (MO) SDT (MO-SDT) configuration based at least in part on one or more conditions being satisfied, or
a second uplink resource associated with a random access configuration based at least in part on the one or more conditions not being satisfied or based at least in part on no MO-SDT configurations being configured for the UE.

16. The method of claim 15, wherein the MO-SDT configuration includes a configured grant (CG) SDT (CG-SDT) configuration or a random access SDT (RA-SDT) configuration, and wherein the communication is associated with:
the CG-SDT configuration based at least in part on a first one or more conditions, from the one or more conditions, being satisfied;
the RA-SDT configuration based at least in part on the first one or more conditions not being satisfied and based at least in part on a second one or more conditions, from the one or more conditions, being satisfied; or
the random access configuration based at least in part on the first one or more conditions and the second one or more conditions not being satisfied.

17. A user equipment (UE) for wireless communication, comprising:
a memory; and
one or more processors, coupled to the memory, configured to:
receive, from a network node, an indication that the UE is to perform a mobile-terminated (MT) small data transmission (SDT) (MT-SDT) operation; and
transmit, to the network node, a communication in response to the indication using:
a first uplink resource associated with a mobile-originated (MO) SDT (MO-SDT) configuration based at least in part on one or more conditions being satisfied, or
a second uplink resource associated with a random access configuration based at least in part on the one or more conditions not being satisfied or based at least in part on no MO-SDT configurations being configured for the UE.

18. The UE of claim 17, wherein the MO-SDT configuration includes a CG-SDT configuration or a RA-SDT configuration, and wherein the communication is associated with:
the CG-SDT configuration based at least in part on a first one or more conditions, from the one or more conditions, being satisfied;
the RA-SDT configuration based at least in part on the first one or more conditions not being satisfied and based at least in part on a second one or more conditions, from the one or more conditions, being satisfied; or
the random access configuration based at least in part on the first one or more conditions and the second one or more conditions not being satisfied.

19. The UE of claim 18, wherein the first one or more conditions include at least one of:
a first condition associated with whether the network node is a serving network node from which the UE received a radio resource control (RRC) communication that caused the UE to transition to an RRC inactive mode,
a second condition associated with whether the CG-SDT configuration is received from the serving network node,
a third condition associated with whether a data volume of pending uplink data across all SDT radio bearers satisfies an uplink data volume threshold,
a fourth condition associated with whether a measurement value of a downlink reference signal satisfies an uplink CG threshold,
a fifth condition associated with whether an SDT timing alignment timer is expired, or
a sixth condition associated with whether time domain resources associated with the first uplink resource at least partially overlap with time domain resources of another communication having a higher priority than the communication.

20. The UE of claim 18, wherein the second one or more conditions include at least one of:
a first condition associated with one or more network nodes, including the network node, from which the UE received the indication that the UE is to perform the MT-SDT operation, a radio resource control (RRC) communication that caused the UE to transition to an RRC inactive mode, and the random access SDT configuration being included in a radio access network (RAN) notification area (RNA) associated with the UE,
a second condition associated with whether a data volume of pending uplink data across all SDT radio bearers satisfies one or more uplink data volume thresholds,
a third condition associated with whether a measurement value of a downlink reference signal satisfies one or more random access SDT threshold, or
a fourth condition associated with whether radio resources associated with the first uplink resource at least partially overlap with radio resources of another communication having a higher priority than the communication.

21. The UE of claim 18, wherein the communication being associated with the random access configuration is further based at least in part on a third one or more conditions being satisfied, wherein the third one or more conditions include at least one of:
a first condition associated with one or more network nodes, including the network node, from which the UE received the indication that the UE is to perform the MT-SDT operation, a radio resource control (RRC) communication that caused the UE to transition to an RRC inactive mode, and the random access configuration, being included in a radio access network (RAN) notification area (RNA) associated with the UE,
a second condition associated with whether a measurement value of a downlink reference signal satisfies one or more SDT thresholds, or
a third condition associated with whether radio resources associated with the second uplink resource at least partially overlap with radio resources of another communication having a higher priority than the communication.

22. The UE of claim 17, wherein the one or more processors are further configured to:
receive configuration information associated with the MT-SDT operation.

23. The UE of claim 22, wherein the configuration information includes a pathloss reference signal configuration, and wherein the one or more processors, to receive the configuration information, are configured to:
receive the pathloss reference signal configuration or a modification to the pathloss reference signal configuration via at least one of radio resource control signaling, medium access control (MAC) control element signaling, or downlink control information signaling.

24. The UE of claim 22, wherein the one or more processors are further configured to:
transmit a UE assistance information (UAI) communication indicating mobility information associated with the UE,
wherein the configuration information indicates a reduced radio resource management (RRM) measurement configuration based at least in part on transmitting the UAI communication.

25. The UE of claim 22, wherein the configuration information indicates a reduced downlink control channel monitoring or timeline configuration, and wherein the one or more processors, to receive the configuration information, are configured to:
receive the reduced downlink control channel monitoring or timeline configuration via at least one of radio resource control signaling, medium access control (MAC) control element signaling, or downlink control information signaling.

26. The UE of claim 22, wherein the configuration information indicates semi-persistent scheduling (SPS) or semi-static resources for a downlink channel associated with the MT-SDT operation based at least in part on second one or more conditions being satisfied, wherein the second one or more conditions include at least one of:
a first condition associated with whether the communication, including a radio resource control (RRC) resume message, is successfully transmitted,
a second condition associated with whether mobility information and a link quality status associated with the UE is reported to the network node,
a third condition associated with whether the indication for any subsequent downlink or uplink communication associated with the MT-SDT operation are received from the network node,
a fourth condition associated with whether a measurement value of a downlink reference signal satisfies a threshold for link quality evaluation and timing alignment timer validation configured for SPS or semi-static communications,
a fifth condition associated with whether the UE is configured with valid uplink resources, for providing hybrid automatic repeat request (HARQ) feedback associated with the MT-SDT operation, that occur prior to an expiration of a SDT timing alignment timer,
a sixth condition associated with whether an SDT error detection timer, that is initiated after an initial transmission or reception of the MT-SDT operation, has expired, or
a seventh condition associated with whether the network node is a serving network node for the UE and is included in a radio access network (RAN) notification area (RNA) associated with the UE.

27. The UE of claim 17, wherein the MT-SDT operation is associated with a session, wherein the one or more processors are further configured to:
detect a termination event; and
terminate the session based at least in part detecting the termination event.

28. The UE of claim 27, wherein the one or more processors, to detect the termination event, are configured to detect that at least one of:
an SDT inactivity timer has expired prior to detecting or decoding a downlink control communication associated with the MT-SDT operation,
a measurement value of a downlink signal does not satisfy an SDT measurement value threshold,
an SDT timing alignment timer has expired prior to transmitting feedback information for a downlink communication associated with the MT-SDT operation,
a geographic location of the UE is outside of a radio access network (RAN) notification area (RNA) associated with the MT-SDT operation,
a system information communication or an emergency notification communication that at least partially overlaps in a time domain with a downlink communication associated with the session,
an SDT failure detection timer has expired,
a quantity of physical random access channel (PRACH) preamble transmissions by the UE satisfies a threshold,
a quantity of retransmissions performed by the UE satisfies a threshold,
a response to the communication has not been received by the UE, or
a power headroom of the UE does not satisfy an SDT power headroom threshold.

29. A network node for wireless communication, comprising:
a memory; and
one or more processors, coupled to the memory, configured to:
transmit an indication, intended for a user equipment (UE), that the UE is to perform a mobile-terminated (MT) small data transmission (SDT) (MT-SDT) operation; and
receive a communication, associated with the UE, in response to the indication using:
a first uplink resource associated with a mobile originated (MO) SDT (MO-SDT) configuration based at least in part on one or more conditions being satisfied, or
a second uplink resource associated with a random access configuration based at least in part on the one or more conditions not being satisfied or based at least in part on no MO-SDT configurations being configured for the UE.

30. The network node of claim 29, wherein the communication is included in a radio resource control (RRC) resume request communication.
